(19) United States
(12) Patent Application Publication
(10) Pub. No.: US 2024/0119508 A1
(43) Pub. Date: Apr. 11, 2024

(54) INITIATING ACTIONS BASED ON ONGOING CUSTOMER JOURNEYS

(71) Applicant: CATCH RETAIL MEDIA LTD., Raanana (IL)

(72) Inventors: Itai LISHNER, Ramat Gan (IL); Shlomi DAYAN, Raanana (IL); Yaniv SERGERT, Ashdod (IL); Lior MICHELZON, Modi'in-Maccabim-Re'ut (IL); Tomer BEN DROR, Herzliya (IL); Dave BEN DOR, Tel Aviv (IL); Rami KANTOR, Rosh Haayin (IL)

(21) Appl. No.: 18/375,536

(22) Filed: Oct. 1, 2023

Related U.S. Application Data
(60) Provisional application No. 63/414,203, filed on Oct. 7, 2022.

(51) Int. Cl. G06Q 30/0601; G06Q 30/02; G06Q 30/0204; G06V 20/40; G06V 30/148

(52) U.S. Cl. CPC G06Q 30/0633; G06Q 30/0204; G06Q 30/0281; G06V 20/41; G06V 30/158

(57) ABSTRACT

Systems, methods and non-transitory computer readable media for initiating actions based on an ongoing customer journey are provided. Customer journey data associated with an ongoing customer journey may be received. The ongoing customer journey may involve an individual and a device associated with the individual in a retail store, such as a shopping cart. The customer journey data may indicate a trajectory of the device in the retail store generated based on data captured using an indoor positioning instrument associated with the device. While the ongoing customer journey is in progress, the customer journey data may be analyzed to determine information associated with the individual. The information associated with the individual may be used to select an action associated with the individual. A digital signal configured to initiate the selected action may be generated.

### CROSS-REFERENCE TO RELATED APPLICATIONS

This application claims the benefit of priority of U.S. Provisional Patent Application No. 63/414,203, filed on Oct. 7, 2022, the disclosures of which incorporated herein by reference in their entirety.

### BACKGROUND OF THE INVENTION

### Technological Field

The disclosed embodiments relate to systems and methods for initiating actions based on ongoing customer journeys in retail stores.

### Background Information

The retail industry has been undergoing a transformative evolution in recent years, driven by advances in technology and changing consumer preferences. Traditional brick-and-mortar stores are facing increasing competition from e-commerce platforms, forcing retailers to seek innovative solutions to enhance the in-store shopping experience. One such solution is the integration of smart shopping carts into the retail environment, which offers a promising avenue to revolutionize the way customers shop and interact with products.

Traditionally, shopping carts have been a ubiquitous fixture in retail stores, serving as simple carriers for customers to transport their selected items. However, these conventional carts offer limited functionality beyond their basic role, often leading to a fragmented and inefficient shopping experience. Smart shopping carts are innovative solutions aimed at revolutionizing the traditional shopping experience by incorporating cutting-edge technology and automation into the retail sector. These smart shopping carts are equipped with various features and capabilities that cater to the evolving needs and preferences of modern consumers, offering a seamless and efficient shopping journey. The inclusion of display screens in smart shopping carts creates an opportunity for delivering content directly to the shopper.

### SUMMARY OF THE INVENTION

In some examples, systems, methods and non-transitory computer readable media for selecting content for presentation in retail stores are provided. In some examples, location data associated with a shopping cart in a retail store may be obtained. Further, a data structure including a plurality of data records may be accessed. Each data record of the plurality of data records may associate a content provider, at least one region of the retail store and a modifiable bid amount. A group of at least two data records that match the location data of the plurality of data records may be identified. The plurality of data records may include at least one data record not included in the group of at least two data records. A particular data record of the group of at least two data records may be selected based on the modifiable bid amounts associated with the group of at least two data records. The particular data record may be associated with a particular content provided and a particular modifiable bid amount. Content associated with the particular content provider may be presented using a display instrument associated with the shopping cart. An account associated with the particular content provider may be updated based on the particular modifiable bid amount.

In some examples, systems, methods and non-transitory computer readable media for initiating actions based on an ongoing customer journey are provided. In some examples, customer journey data associated with an ongoing customer journey may be received. The ongoing customer journey may involve an individual and a shopping cart in a retail store. The customer journey data may indicate a trajectory of the shopping cart in the retail store generated based on data captured using an indoor positioning instrument associated with the shopping cart. While the ongoing customer journey is in progress, the customer journey data may be analyzed to determine information associated with the individual. The information associated with the individual may be used to select an action associated with the individual. A digital signal configured to initiate the selected action may be generated.

### BRIEF DESCRIPTION OF DRAWINGS

FIG. 1A is a block diagram illustrating some possible flows of information, consistent with some embodiments of the present disclosure.

FIG. 1B is a block diagram illustrating a possible implementation of a communicating system, consistent with some embodiments of the present disclosure.

FIGS. 2A and 2B are block diagrams illustrating some possible implementations of an apparatus, consistent with some embodiments of the present disclosure.

FIG. 2C is a schematic illustration of a smart shopping cart, consistent with some embodiments of the present disclosure.

FIG. 3 is a diagram illustrating an exemplary embodiment of a memory containing software modules, consistent with some embodiments of the present disclosure.

FIG. 4 is a flowchart of an exemplary method for selecting content for presentation in retail stores, consistent with some embodiments of the present disclosure.

FIG. 5 is a diagram illustrating data records, consistent with some embodiments of the present disclosure.

FIG. 6A is a flowchart of an exemplary method for initiating actions based on ongoing customer journeys, consistent with some embodiments of the present disclosure.

FIG. 6B is a flowchart of an exemplary method for initiating actions based on ongoing customer journeys, consistent with some embodiments of the present disclosure.

FIG. 7 is a diagram illustrating two different customer journeys over a floorplan of a retail store, consistent with some embodiments of the present disclosure.

### DETAILED DESCRIPTION OF THE INVENTION

Unless specifically stated otherwise, as apparent from the following discussions, it is appreciated that throughout the specification discussions utilizing terms such as “processing”, “calculating”, “computing”, “determining”, “generating”, “setting”, “configuring”, “selecting”, “defining”, “applying”, “obtaining”, “monitoring”, “providing”, “identifying”, “segmenting”, “classifying”, “analyzing”, “associating”, “extracting”, “storing”, “receiving”, “transmitting”, “presenting”, “causing”, “using”, “basing”, “halting” or the like, include action and/or processes of a computer that manipulate and/or transform data into other data, said data represented as physical quantities, for example such as electronic quantities, and/or said data representing the physical objects. The terms “computer”, “processor”, “controller”, “processing unit”, “computing unit”, and “processing module” should be expansively construed to cover any kind of electronic device, component or unit with data processing capabilities, including, by way of non-limiting example, a personal computer, a wearable computer, a tablet, a smartphone, a server, a computing system, a cloud computing platform, a communication device, a processor (for example, digital signal processor (DSP), an image signal processor (ISR), a microcontroller, a field programmable gate array (FPGA), an application specific integrated circuit (ASIC), a central processing unit (CPA), a graphics processing unit (GPU), a visual processing unit (VPU), and so on), possibly with embedded memory, a single core processor, a multi core processor, a core within a processor, any other electronic computing device, or any combination of the above.

The operations in accordance with the teachings herein may be performed by a computer specially constructed or programmed to perform the described functions.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) may be included in at least one embodiment of the presently disclosed subject matter. Thus, the appearance of the phrase “one case”, “some cases”, “other cases” or variants thereof does not necessarily refer to the same embodiment(s). As used herein, the term “and/or” includes any and all combinations of one or more of the associated listed items. As used herein, the phrase “may not” means “might not”.

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

The term “image sensor” is recognized by those skilled in the art and refers to any device configured to capture images, a sequence of images, videos, and so forth. This includes sensors that convert optical input into images, where optical input can be visible light (like in a camera), radio waves, microwaves, terahertz waves, ultraviolet light, infrared light, x-rays, gamma rays, and/or any other light spectrum. This also includes both 2D and 3D sensors. Examples of image sensor technologies may include: CCD, CMOS, NMOS, and so forth. 3D sensors may be implemented using different technologies, including: stereo camera, active stereo camera, time of flight camera, structured light camera, radar, range image camera, and so forth.

In embodiments of the presently disclosed subject matter, one or more stages illustrated in the figures may be executed in a different order and/or one or more groups of stages may be executed simultaneously. The figures illustrate a general schematic of the system architecture in accordance embodiments of the presently disclosed subject matter. Each module in the figures can be made up of any combination of software, hardware and/or firmware that performs the functions as defined and explained herein. The modules in the figures may be centralized in one location or dispersed over more than one location.

It should be noted that some examples of the presently disclosed subject matter are not limited in application to the details of construction and the arrangement of the components set forth in the following description or illustrated in the drawings. The invention can be capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing may have the same use and description as in the previous drawings.

The drawings in this document may not be to any scale. Different figures may use different scales and different scales can be used even within the same drawing, for example different scales for different views of the same object or different scales for the two adjacent objects.

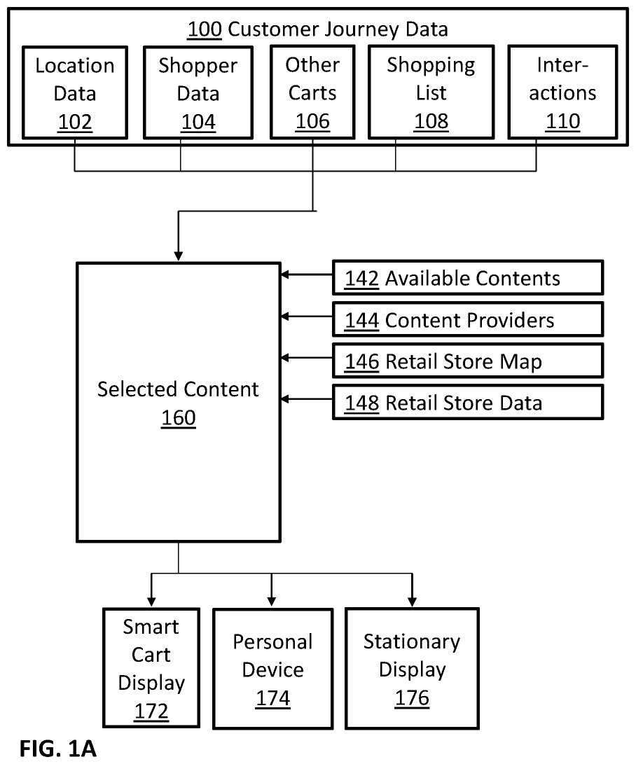

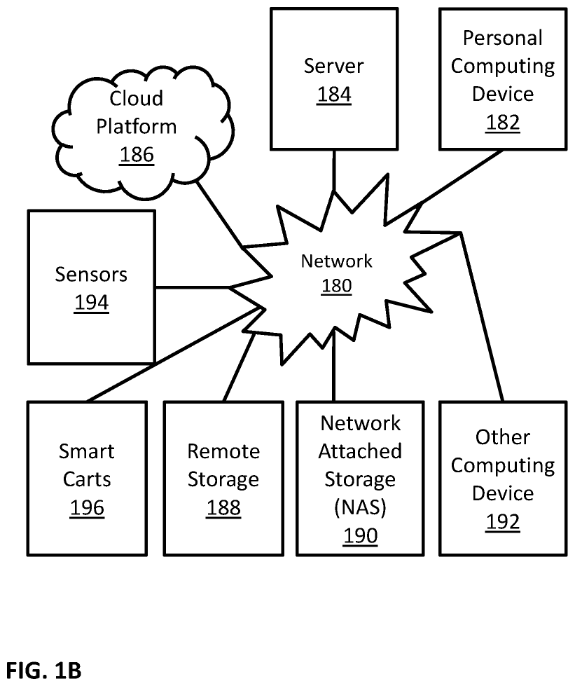

FIG. 1A is a block diagram illustrating some possible flows of information consistent with some embodiments of the present disclosure. In this example, customer journey data 100 may comprise at least one of location data 102, shopper data 104, data associated with other carts 106, shopping list 108 or interactions data 110. In other examples, the customer journey data 100 may include additional components or fewer components. In one example, inputs 100 may comprise information encoded in a digital format and/or in a digital signal.

In some examples, location data 102 may comprise locations from a journey of a customer in a retail store. In one example, the locations may be determined using a positioning system, such as an indoor positioning system. In one example, a shopping cart may include an image sensor, and image data captured using the image sensor may be analyzed (for example, using an ego-localization algorithm) to determine the locations of the cart in the retail store during the customer journey. In one example, a shopping cart may include an accelerometer and/or a gyroscope, and acceleration data captured using the accelerometer and/or gyroscope may be analyzed to determine the locations of the shopping cart in the retail store during the customer journey. In one example, a shopping cart may include a wireless receiver (for example, as part of communication module 230), and signals captured using the wireless receiver may be analyzed to determine the locations of the shopping cart in the retail store during the customer journey relative to beacons (for example, relative to beacons that are located in known positions within the retail store), for example using a triangulation algorithm, using time-of-flight algorithm, and so forth. In one example, a shopping cart may include a magnetic sensor, and signals captured using the magnetic sensor may be analyzed to determine the locations of the cart in the retail store during the customer journey, for example using a map of magnetic signatures in different portions of the retail store.

In some examples, shopper data 104 may include information associated with the shopper and/or a profile of the shopper. For example, shopper data may be determined by analyzing customer journey data associated with the shopper using step 604. In another example, shopper data 104 may indicate at least one demographic characteristic associated with the shopper (such as age, gender, ethnicity, income level, employment status, marital status, etc.). In yet another example, shopper data 104 may be based on inputs entered by the shopper using a touch input device associated with the shopping cart. In an additional example, shopper data 104 may be based on a shopping list associated with the shopper (such as shopping list 108). In one example, a handwritten version of the shopping list may be received (for example, an image of the handwritten version of the shopping list may be received and/or captured), the handwritten version may be analyzed to obtain a digital version of the shopping list (for example, using an Optical Character Recognition algorithm, using a multimodal LLM, etc.), and/or shopper data 104 may be further based on at least one of shapes of characters in the handwritten version, sizes of characters in the handwritten version, spacing between characters in the handwritten version, spacing between words in the handwritten version, or spacing between lines in the handwritten version. In another example, shopper data 104 may be based on reactions of the shopper to presentations made using a display instrument associated with a shopping cart. For example, the display instrument may be or include an input instrument (such as a touch screen, a keyboard, a microphone, a camera, etc.), and shopper data 104 may be based on at least one of a selection made by the shopper using the input instrument in response to the presentations, information provided by the shopper using the input instrument in response to the presentations, a pace of interaction of the shopper in response to the presentations, and so forth. In another example, shopper data 104 may be based on movements of the shopping cart after the presentations. In yet another example, shopper data 104 may be based on a pace associated with the reactions. In some examples, shopper data 104 may be based on past purchases of the shopper from at least one completed historic journey of the shopper (for example, at least one completed historic journey of the shopper in the retail store, at least one completed historic journey of the shopper in a different retail store, at least one completed historic journey of the shopper in a single retail store, at least one completed historic journey of the shopper in at least two retail stores, and so forth). For example, shopper data 104 may be based on at least one of product types, quantities or time of sale of the past purchases of the shopper. In one example, historic data may be used to analyze activities of the shopper in the ongoing customer journey to obtain the purchases from the at least one completed historic journey of the shopper, for example as described below. In one example, a loyalty account associated with the shopper may be used to obtain the purchases from the at least one completed historic journey of the shopper.

In some examples, data associated with other carts 106 may include indications of proximity of the other carts to the shopping cart associated with customer journey data 100, locations of the other carts, trajectories of other carts, shoppers associated with the other carts, shopping lists associated with the other carts, and so forth.

In some examples, shopping list 108 may include an indication of product types and/or quantities associated with the different product types. In one example, shopping list 108 may include an indication of an order among the different product types. In one example, a handwritten version of the shopping list may be received (for example, an image of the handwritten version of the shopping list may be received and/or captured). Further, the handwritten version may be analyzed to obtain a digital version of the shopping list (for example, using an Optical Character Recognition algorithm, using a multimodal LLM, etc.). In this example, shopping list 108 may further indicate at least one of shapes of characters in the handwritten version, sizes of characters in the handwritten version, spacing between characters in the handwritten version, spacing between words in the handwritten version, or spacing between lines in the handwritten version. In one example, shopping list 108 may be received from an individual using an input instrument. In one example, shopping list 108 may be received from an external device (for example, via a digital communication network). In one example, shopping list 108 may be generated automatically, for example based on shopper data 104.

In some examples, interactions data 110 may include information associated with interactions of an individual associated with customer journey data 100 while the customer journey is ongoing. For example, the interactions may include at least one of interactions with a computing device associated with a shopping cart associated with customer journey data 100, interactions with products (such as purchases, placing products in the shopping cart, stopping next to a product, etc.) or with other items of the retail store, interactions with other individuals in the retail store, and so forth. In one example, interactions data 110 may be based on a pace associated with the interactions. In one example, interactions data 110 may include reactions of the individual to presentations made using a display instrument associated with a shopping cart. For example, the display instrument may be or include an input instrument (such as a touch screen, a keyboard, a microphone, a camera, etc.), and interactions data 110 may include at least one of a selection made by the individual using the input instrument in response to the presentations, information provided by the individual using the input instrument in response to the presentations, a pace of interaction of the individual in response to the presentations, and so forth.

In some examples, available contents 142 may include one or more contents available for presentation in one or more retail stores. The one or more contents may include visual contents (such as images, videos, animations, logos, graphics, etc.), audible contents, textual contents, interactive contents, commercial contents, informative contents, and so forth. In some examples, the one or more contents may be available for presentation via at least one of smart cart display 172, personal device 174 or stationary display 176. In some examples, available contents 142 may be stored in at least one of a memory unit 210, a data structure (such as data records 500), a database, a Content Management System (CMS), or an external computing device. In one example, available contents 142 may be provided and/or generated by content providers 144, for example in response to a digital signal transmitted to the content provider.

In some examples, content providers 144 may include one or more entities associated with available contents 142. For example, content providers 144 may provide or generate one or more content of available contents 142, for example in response to a digital signal transmitted to the content provider. Some non-limiting examples of such content providers may include an advertiser, an operator of the retail store, or a regulatory entity. In some examples, digital identifiers of different content providers may be stored in at least one of a memory unit 210, a data structure (such as data records 500), a database, or an external computing device.

In some examples, retail store map 146 may include a map of a retail store. For example, retail store map 146 may include at least one of a floorplan of the retail store, a three-dimensional model of the retail store, a layout of the retail store, a map of a plan for the retail store, a map of an actual state of the retail store, one or more planograms associated with the store, one or more realograms associated with the store, or an association of a portion of the retail store with at least one of a product type, a product category of a brand. In some examples, retail store map 146 may be stored in a digital format in at least one of a memory unit 210, a data structure, a database, or an external computing device.

In some examples, retail store data 148 may include information associated with a retail store. Some non-limiting examples of such information associated with the retail store may include the store's name, the store's location, the store's opening hours, the store's inventory, the store's historic sales data, and so forth. In one example, retail store data 148 may include retail store map 146. In one example, retail store data 148 may be stored in a digital format in at least one of a memory unit 210, a data structure, a database, or an external computing device.

In the example of FIG. 1A, any part of customer journey data 100 may be used to select content 160 for presentation in a retail store. In some examples, the selection of content 160 may be further based on at least one of available contents 142, content providers 144, retail store map 146, or retail store data 148. In one example, content 160 may be selected from available contents 142 based on at least one of any part of customer journey data 100, content providers 144, retail store map 146, or retail store data 148. In one example, content 160 may be provided and/or generated by content providers 144 based on at least one of any part of customer journey data 100, retail store map 146, or retail store data 148. In one example, selected content 160 may include at least one of a visual content (such as an image, a video clip, an animation, a logo, a graphical content, etc.), an audible content, a textual content, an interactive content, a commercial content, an informative content, and so forth. In some examples, content 160 may be selected using step 408 and/or method 400. In some examples, content 160 and/or a presentation scheme for content 160 may be selected using step 606 and/or method 600.

In the example of FIG. 1A, selected content 160 may be displayed via at least one of smart cart display 172, personal device 174 or stationary display 176. In one example, smart cart display 172 may include any display screen included and/or mounted to a shopping cart, such as a flat screen, a touchscreen, and so forth. In one example, personal device 174 may include a personal device of a shopper, such as a smartphone, a wearable computing device that includes a display system (such as a smartwatch, a wearable extended reality appliance, personal computing device 182, etc.), and so forth. In one example, stationary display 176 may include any device positioned in a fixed position in a retail store. In one example, displaying selected content 160 may include transmitting one or more digital signals configured to cause a display instrument (such as smart cart display 172, personal device 174 or stationary display 176) to display selected content 160.

FIG. 1B is a block diagram illustrating a possible implementation of a communicating system consistent with some embodiments of the present disclosure. In this example, apparatuses may communicate using communication network 180 or directly with each other. Some non-limiting examples of such apparatuses may include at least one of personal computing device 182 (such as a mobile phone, smartphone, tablet, personal computer, smartwatch, etc.), server 184, cloud platform 186, remote storage 188 and network attached storage (NAS) 190, other computing devices 192, sensors 194 or smart shopping carts 196. Some non-limiting examples of communication network 180 may include a digital communication network, analog communication network, the Internet, phone networks, cellular networks, satellite communication networks, private communication networks, virtual private networks (VPN), and so forth. FIG. 1B illustrates a possible implementation of a communication system. In some embodiments, other communication systems that enable communication between apparatuses may be used. Some non-limiting examples of sensors 194 may include at least one of a remote sensor, a sensor integrated in a computing device, image sensors (such as image sensor 260), audio sensors (such as audio sensors 250), motion sensors (such as motion sensor 270), positioning sensors (such as positioning sensors 275), touch sensors, proximity sensors, temperature sensors, and so forth.

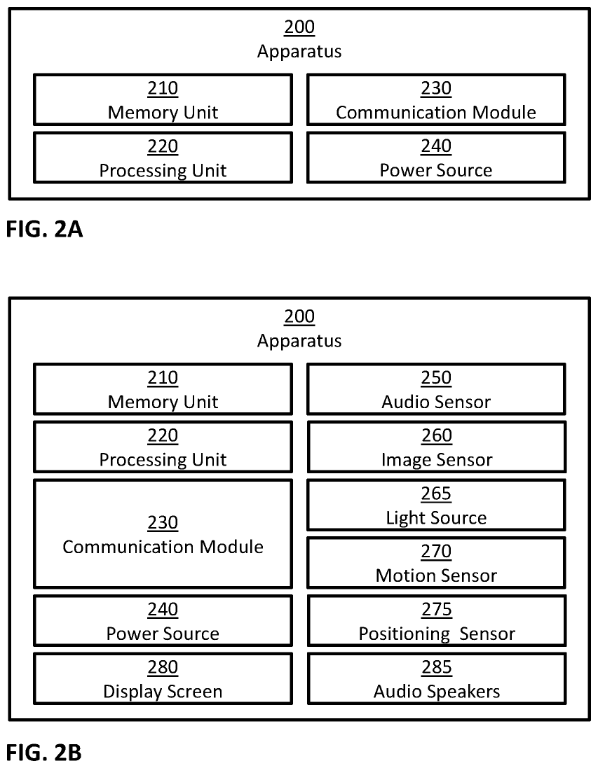

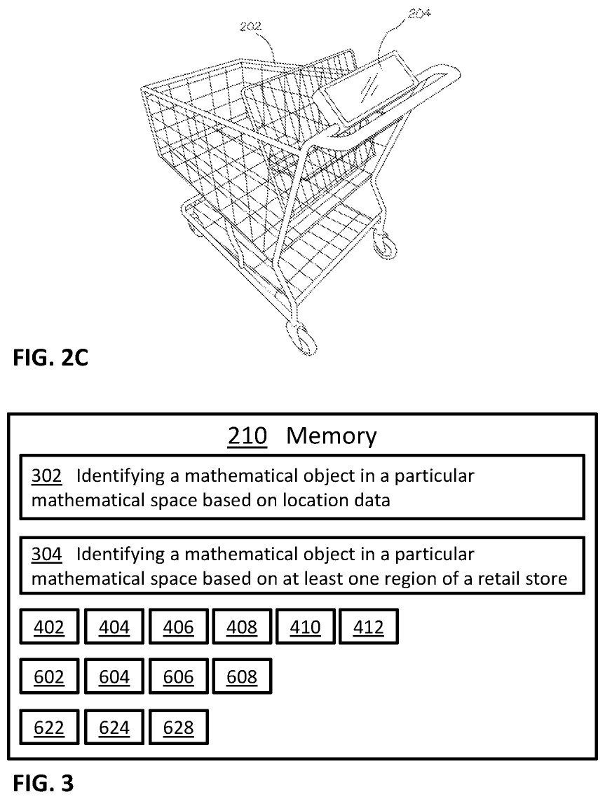

FIG. 2A is a block diagram illustrating a possible implementation of apparatus 200. In this example, apparatus 200 may comprise: one or more memory units 210, one or more processing units 220, and one or more image sensors 260. In some implementations, apparatus 200 may comprise additional components, while some components listed above may be excluded. FIG. 2B is a block diagram illustrating a possible implementation of apparatus 200. In this example, apparatus 200 may comprise: one or more memory units 210, one or more processing units 220, one or more communication modules 230, one or more power sources 240, one or more audio sensors 250, one or more image sensors 260, one or more light sources 265, one or more motion sensors 270, and one or more positioning sensors 275. In some implementations, apparatus 200 may comprise additional components, while some components listed above may be excluded. For example, in some implementations, apparatus 200 may also comprise at least one of the following: one or more barometers; one or more user input devices; one or more user output devices; and so forth. In another example, in some implementations at least one of the following may be excluded from apparatus 200: memory units 210, communication modules 230, power sources 240, audio sensors 250, image sensors 260, light sources 265, motion sensors 270, and positioning sensors 275. In some embodiments, apparatus 200 may be included and/or may be used as a personal computing device (such as personal computing device 182), a personal computer, a tablet, a mobile phone, a smartphone, a smartwatch, a computing device, a wearable computing device, a head-mounted computing device, a server (such as server 184), a computational node of a cloud platform (for example, of cloud platform 186), a router, a remote storage unit (such as remote storage 188), NAS (such as NAS 190), a sensor (such as sensors 194), a smart shopping cart (such as smart shopping carts 196), and so forth.

In some embodiments, one or more power sources 240 may be configured to power apparatus 200. Possible implementation examples of power sources 240 may include: one or more electric batteries; one or more capacitors; one or more connections to external power sources; one or more power convertors; any combination of the above; and so forth.

In some embodiments, the one or more processing units 220 may be configured to execute software programs. For example, processing units 220 may be configured to execute software programs stored on the memory units 210. In some cases, the executed software programs may store information in memory units 210. In some cases, the executed software programs may retrieve information from the memory units 210. Possible implementation examples of the processing units 220 may include: one or more single core processors, one or more multicore processors; one or more controllers; one or more application processors; one or more system on a chip processors; one or more central processing units; one or more graphical processing units; one or more neural processing units; any combination of the above; and so forth.

In some embodiments, the one or more communication modules 230 may be configured to receive and transmit information. For example, control signals may be transmitted and/or received through communication modules 230. In another example, information received though communication modules 230 may be stored in memory units 210. In an additional example, information retrieved from memory units 210 may be transmitted using communication modules 230. In another example, input data may be transmitted and/or received using communication modules 230. Examples of such input data may include: input data inputted by a user using user input devices; information captured using one or more sensors; and so forth. Examples of such sensors may include: audio sensors 250; image sensors 260; motion sensors 270; positioning sensors 275; temperature sensors; and so forth.

In some embodiments, the one or more audio sensors 250 may be configured to capture audio by converting sounds to digital information. Some examples of audio sensors 250 may include: microphones, unidirectional microphones, bidirectional microphones, cardioid microphones, omnidirectional microphones, onboard microphones, wired microphones, wireless microphones, any combination of the above, and so forth. In some examples, the captured audio may be stored in memory units 210. In some additional examples, the captured audio may be transmitted using communication modules 230, for example to other computerized devices. In some examples, processing units 220 may control the above processes. For example, processing units 220 may control at least one of: capturing of the audio; storing the captured audio; transmitting of the captured audio; and so forth. In some cases, the captured audio may be processed by processing units 220. For example, the captured audio may be compressed by processing units 220; possibly followed: by storing the compressed captured audio in memory units 210; by transmitted the compressed captured audio using communication modules 230; and so forth. In another example, the captured audio may be processed using speech recognition algorithms. In another example, the captured audio may be processed using speaker recognition algorithms.

In some embodiments, the one or more image sensors 260 may be configured to capture visual information by converting light to: images; sequence of images; videos; 3D images; sequence of 3D images; 3D videos; and so forth. In some examples, the captured visual information may be stored in memory units 210. In some additional examples, the captured visual information may be transmitted using communication modules 230, for example to other computerized devices. In some examples, processing units 220 may control the above processes. For example, processing units 220 may control at least one of: capturing of the visual information; storing the captured visual information; transmitting of the captured visual information; and so forth. In some cases, the captured visual information may be processed by processing units 220. For example, the captured visual information may be compressed by processing units 220; possibly followed: by storing the compressed captured visual information in memory units 210; by transmitted the compressed captured visual information using communication modules 230; and so forth. In another example, the captured visual information may be processed in order to: detect objects, detect events, detect action, detect face, detect people, recognize person, and so forth.

In some embodiments, the one or more light sources 265 may be configured to emit light, for example in order to enable better image capturing by image sensors 260. In some examples, the emission of light may be coordinated with the capturing operation of image sensors 260. In some examples, the emission of light may be continuous. In some examples, the emission of light may be performed at selected times. The emitted light may be visible light, infrared light, x-rays, gamma rays, and/or in any other light spectrum. In some examples, image sensors 260 may capture light emitted by light sources 265, for example in order to capture 3D images and/or 3D videos using active stereo method.

In some embodiments, the one or more motion sensors 270 may be configured to perform at least one of the following: detect motion of objects in the environment of apparatus 200; measure the velocity of objects in the environment of apparatus 200; measure the acceleration of objects in the environment of apparatus 200; detect motion of apparatus 200; measure the velocity of apparatus 200; measure the acceleration of apparatus 200; and so forth. In some implementations, the one or more motion sensors 270 may comprise one or more accelerometers configured to detect changes in proper acceleration and/or to measure proper acceleration of apparatus 200. In some implementations, the one or more motion sensors 270 may comprise one or more gyroscopes configured to detect changes in the orientation of apparatus 200 and/or to measure information related to the orientation of apparatus 200. In some implementations, motion sensors 270 may be implemented using image sensors 260, for example by analyzing images captured by image sensors 260 to perform at least one of the following tasks: track objects in the environment of apparatus 200; detect moving objects in the environment of apparatus 200; measure the velocity of objects in the environment of apparatus 200; measure the acceleration of objects in the environment of apparatus 200; measure the velocity of apparatus 200, for example by calculating the egomotion of image sensors 260; measure the acceleration of apparatus 200, for example by calculating the egomotion of image sensors 260; and so forth. In some implementations, motion sensors 270 may be implemented using image sensors 260 and light sources 265, for example by implementing a LIDAR using image sensors 260 and light sources 265. In some implementations, motion sensors 270 may be implemented using one or more RADARs. In some examples, information captured using motion sensors 270: may be stored in memory units 210, may be processed by processing units 220, may be transmitted and/or received using communication modules 230, and so forth.

In some embodiments, the one or more positioning sensors 275 may be configured to obtain positioning information of apparatus 200, to detect changes in the position of apparatus 200, and/or to measure the position of apparatus 200. In some examples, positioning sensors 275 may be implemented using one of the following technologies: Global Positioning System (GPS), GLObal NAvigation Satellite System (GLONASS), Galileo global navigation system, BeiDou navigation system, other Global Navigation Satellite Systems (GNSS), Indian Regional Navigation Satellite System (IRNSS), Local Positioning Systems (LPS), Real-Time Location Systems (RTLS), Indoor Positioning System (IPS), Wi-Fi based positioning systems, cellular triangulation, and so forth. In some examples, information captured using positioning sensors 275 may be stored in memory units 210, may be processed by processing units 220, may be transmitted and/or received using communication modules 230, and so forth.

In some embodiments, the one or more temperature sensors may be configured to detect changes in the temperature of the environment of apparatus 200 and/or to measure the temperature of the environment of apparatus 200. In some examples, information captured using temperature sensors may be stored in memory units 210, may be processed by processing units 220, may be transmitted and/or received using communication modules 230, and so forth.

In some embodiments, the one or more user input devices may be configured to allow one or more users to input information. In some examples, user input devices may comprise at least one of the following: a keyboard, a mouse, a touch pad, a touch screen, a joystick, a microphone, an image sensor, and so forth. In some examples, the user input may be in the form of at least one of: text, sounds, speech, hand gestures, body gestures, tactile information, and so forth. In some examples, the user input may be stored in memory units 210, may be processed by processing units 220, may be transmitted and/or received using communication modules 230, and so forth.

In some embodiments, the one or more user output devices may be configured to provide output information to one or more users. In some examples, such output information may comprise of at least one of: notifications, feedbacks, reports, and so forth. In some examples, user output devices may comprise at least one of: one or more audio output devices (such as audio speakers 285); one or more textual output devices; one or more visual output devices (such as display screen 280); one or more tactile output devices; and so forth. In some examples, the one or more audio output devices may be configured to output audio to a user, for example through: a headset, a set of speakers, and so forth. In some examples, the one or more visual output devices may be configured to output visual information to a user, for example through: a display screen, an augmented reality display system, a printer, a LED indicator, and so forth. In some examples, the one or more tactile output devices may be configured to output tactile feedbacks to a user, for example through vibrations, through motions, by applying forces, and so forth. In some examples, the output may be provided: in real time, offline, automatically, upon request, and so forth. In some examples, the output information may be read from memory units 210, may be provided by a software executed by processing units 220, may be transmitted and/or received using communication modules 230, and so forth.

FIG. 2C is a schematic illustration of a smart shopping cart, consistent with some embodiments of the present disclosure. In one example, shopping cart 202 may include a computing device that includes a display screen 204. In another example, a computing device that includes a display screen 204 may be mounted to or included in shopping cart 202. One non-limiting implementation of such computing device is apparatus 200. One non-limiting implementation of such display screen is display screen 280.

FIG. 3 is a block diagram illustrating an exemplary embodiment of a memory 210 containing software modules. In this example, memory 210 contains software modules 302, 304, 402, 404, 406, 408, 410, 412, 602, 604, 606, 608, 622, 624 and/or 628. In other examples, memory 210 may contain additional modules or fewer modules. The modules are described in more details below. In one example, at least one of these modules may include data and/or computer implementable instructions that when executed by at least one processor (such as processing units 220) may cause the at least one processor to perform operations for carrying out actions corresponding to at least one of these modules. Any one of these modules may be executed alone or in combination with other modules. In particular, any one of these modules may be used as a step in a method, for example as described below. Further, any step in the methods described below may be used independently of the method as a module. It is understood that herein any reference to a step may equally refer to a module and vice versa. In one example, a system may comprise at least one processing unit (such as processing units 220) configured to perform operations for carrying out actions corresponding to at least one of these modules.

In some examples, module 302 may comprise identifying a mathematical object in a particular mathematical space based on specific location data (such as a position, a spatial orientation, a time series of locations, a trajectory, etc.). For example, module 302 may use a function or an injective function mapping location data instances to mathematical objects in the particular mathematical space based on the specific location data to identify the mathematical object. In another example, module 302 may use a signal processing algorithm to embed the time series of locations and/or the trajectory associated with the specific location data in the particular mathematical space, thereby identifying the mathematical object. In yet another example, a position associated with the specific location data may include numerical components associated with different coordinates, and module 302 may identify the mathematical object based on the values of the numerical components. In an additional example, a spatial orientation associated with the specific location data may include a mathematical vector that includes numerical components, and module 302 may identify the mathematical object based on the values of the numerical components.

In some examples, module 304 may comprise identifying a mathematical object in a particular mathematical space based on at least one region of a retail store. For example, a function or an injective function mapping regions of retail stores to mathematical objects in the particular mathematical space may be used based on the at least one region of the retail store. In another example, the at least one region of the retail store may be defined using a boundary contour, and module 304 may identify the mathematical object based on the boundary contour.

In some embodiments, a method (such as methods 400, 600 or 620) may comprise of one or more steps. In some examples, these methods, as well as all individual steps therein, may be performed by various aspects of apparatus 200, of a computerized device, and so forth. For example, a system comprising of at least one processor, such as processing units 220, may perform any of these methods as well as all individual steps therein, for example, processing units 220 may execute software instructions stored in memory units 210 to perform operations corresponding to the steps. In some examples, these methods, as well as all individual steps therein, may be performed by a dedicated hardware. In some examples, a computer readable medium, such as a non-transitory computer readable medium, may store data and/or computer implementable instructions that when executed by at least one processor causes the at least one processor to perform operations for carrying out at least one of these methods as well as all individual steps therein and/or at least one of these steps. In some examples, a system may comprise at least one processing unit (such as processing units 220) configured to perform operations for carrying out at least one of these methods as well as all individual steps therein and/or at least one of these steps. Some non-limiting examples of possible execution manners of a method may include continuous execution (for example, returning to the beginning of the method or to an intermediate step of the method once the method normal execution ends), periodically execution, executing the method at selected times, execution upon the detection of a trigger (some non-limiting examples of such trigger may include a trigger from a user, a trigger from another process, a trigger from an external computing device, etc.), and so forth.

In some embodiments, machine learning algorithms (also referred to as machine learning models in the present disclosure) may be trained using training examples, for example in the cases described below. Some non-limiting examples of such machine learning algorithms may include classification algorithms, data regressions algorithms, image segmentation algorithms, visual detection algorithms (such as object detectors, face detectors, person detectors, motion detectors, edge detectors, etc.), visual recognition algorithms (such as face recognition, person recognition, object recognition, etc.), speech recognition algorithms, mathematical embedding algorithms, natural language processing algorithms, support vector machines, random forests, nearest neighbors algorithms, deep learning algorithms, artificial neural network algorithms, convolutional neural network algorithms, recurrent neural network algorithms, linear machine learning models, non-linear machine learning models, ensemble algorithms, and so forth. For example, a trained machine learning algorithm may comprise an inference model, such as a predictive model, a classification model, a data regression model, a clustering model, a segmentation model, an artificial neural network (such as a deep neural network, a convolutional neural network, a recurrent neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyper parameters, where the hyper parameters may be set manually by a person or automatically by an process external to the machine learning algorithm (such as a hyper parameter search algorithm), and the parameters of the machine learning algorithm may be set by the machine learning algorithm based on the training examples. In some implementations, the hyper-parameters may be set based on the training examples and the validation examples, and the parameters may be set based on the training examples and the selected hyper-parameters. For example, given the hyper-parameters, the parameters may be conditionally independent of the validation examples.

In some embodiments, trained machine learning algorithms (also referred to as machine learning models and trained machine learning models in the present disclosure) may be used to analyze inputs and generate outputs, for example in the cases described below. In some examples, a trained machine learning algorithm may be used as an inference model that when provided with an input generates an inferred output. For example, a trained machine learning algorithm may include a classification algorithm, the input may include a sample, and the inferred output may include a classification of the sample (such as an inferred label, an inferred tag, and so forth). In another example, a trained machine learning algorithm may include a regression model, the input may include a sample, and the inferred output may include an inferred value corresponding to the sample. In yet another example, a trained machine learning algorithm may include a clustering model, the input may include a sample, and the inferred output may include an assignment of the sample to at least one cluster. In an additional example, a trained machine learning algorithm may include a classification algorithm, the input may include an image, and the inferred output may include a classification of an item depicted in the image. In yet another example, a trained machine learning algorithm may include a regression model, the input may include an image, and the inferred output may include an inferred value corresponding to an item depicted in the image (such as an estimated property of the item, such as size, volume, age of a person depicted in the image, cost of a product depicted in the image, and so forth). In an additional example, a trained machine learning algorithm may include an image segmentation model, the input may include an image, and the inferred output may include a segmentation of the image. In yet another example, a trained machine learning algorithm may include an object detector, the input may include an image, and the inferred output may include one or more detected objects in the image and/or one or more locations of objects within the image. In some examples, the trained machine learning algorithm may include one or more formulas and/or one or more functions and/or one or more rules and/or one or more procedures, the input may be used as input to the formulas and/or functions and/or rules and/or procedures, and the inferred output may be based on the outputs of the formulas and/or functions and/or rules and/or procedures (for example, selecting one of the outputs of the formulas and/or functions and/or rules and/or procedures, using a statistical measure of the outputs of the formulas and/or functions and/or rules and/or procedures, and so forth).

In some embodiments, artificial neural networks may be configured to analyze inputs and generate corresponding outputs, for example in the cases described below. Some non-limiting examples of such artificial neural networks may comprise shallow artificial neural networks, deep artificial neural networks, feedback artificial neural networks, feed forward artificial neural networks, autoencoder artificial neural networks, probabilistic artificial neural networks, time delay artificial neural networks, convolutional artificial neural networks, recurrent artificial neural networks, long short term memory artificial neural networks, and so forth. In some examples, an artificial neural network may be configured manually. For example, a structure of the artificial neural network may be selected manually, a type of an artificial neuron of the artificial neural network may be selected manually, a parameter of the artificial neural network (such as a parameter of an artificial neuron of the artificial neural network) may be selected manually, and so forth. In some examples, an artificial neural network may be configured using a machine learning algorithm. For example, a user may select hyper-parameters for the an artificial neural network and/or the machine learning algorithm, and the machine learning algorithm may use the hyper-parameters and training examples to determine the parameters of the artificial neural network, for example using back propagation, using gradient descent, using stochastic gradient descent, using mini-batch gradient descent, and so forth. In some examples, an artificial neural network may be created from two or more other artificial neural networks by combining the two or more other artificial neural networks into a single artificial neural network.

In some embodiments, generative models may be configured to generate new content, such as textual content, visual content, auditory content, graphical content, and so forth. In some examples, generative models may generate new content without input. In other examples, generative models may generate new content based on an input. In one example, the new content may be fully determined from the input, where every usage of the generative model with the same input will produce the same new content. In another example, the new content may be associated with the input but not fully determined from the input, where every usage of the generative model with the same input may product a different new content that is associated with the input. In some examples, a generative model may be a result of training a machine learning generative algorithm with training examples. An example of such training example may include a sample input, together with a sample content associated with the sample input. Some non-limiting examples of such generative models may include Deep Generative Model (DGM), Generative Adversarial Network model (GAN), auto-regressive model, Variational AutoEncoder (VAE), transformers based generative model, artificial neural networks based generative model, hard-coded generative model, and so forth.

A Large Language Model (LLM) is a generative language model with a large number of parameters (usually billions or more) trained on large corpus of unlabeled data (usually trillions of words or more) in a self-supervised learning scheme and/or a semi-supervised learning scheme. While models trained using a supervised learning scheme with label data are fitted to the specific tasks they were trained for, LLM can handle wide range of tasks that the model was never specifically trained for, including ill-defined tasks. It is common to provide LLM with instructions in natural language, sometimes referred to as prompts. For example, to cause a LLM to count the number of people that objected to a proposed plan in a meeting, one might use the following prompt, ‘Please read the meeting minutes. Of all the speakers in the meeting, please identify those who objected to the plan proposed by Mr. Smith at the beginning of the meeting. Please list their names, and count them.’ Further, after receiving a response from the LLM, it is common to refine the task or to provide subsequent tasks in natural language. For example, ‘Also count for each of these speakers the number of words said’, ‘Of these speakers, could you please identify who is the leader?’ or ‘Please summarize the main objections’. LLM may generate textual outputs in natural language, or in a desired structured format, such as a table or a formal language (such as a programming language, a digital file format, and so forth). In many cases, a LLM may be part of a multimodal model, allowing the model to analyze both textual inputs as well as other kind of inputs (such as images, videos, audio, sensor data, telemetries, and so forth) and/or to generate both textual outputs as well as other kinds of outputs (such as images, videos, audio, telemetries, and so forth).

Some non-limiting examples of audio data may include audio recordings, audio stream, audio data that includes speech, audio data that includes music, audio data that includes ambient noise, digital audio data, analog audio data, digital audio signals, analog audio signals, mono audio data, stereo audio data, surround audio data, audio data captured using at least one audio sensor (such as audio sensor 250), audio data generated artificially, and so forth. In one example, audio data may be generated artificially from textual content, for example using text-to-speech algorithms. In another example, audio data may be generated using a generative machine learning model. In some embodiments, analyzing audio data (for example, by the methods, steps and modules described herein) may comprise analyzing the audio data to obtain a preprocessed audio data, and subsequently analyzing the audio data and/or the preprocessed audio data to obtain the desired outcome. One of ordinary skill in the art will recognize that the followings are examples, and that the audio data may be preprocessed using other kinds of preprocessing methods. In some examples, the audio data may be preprocessed by transforming the audio data using a transformation function to obtain a transformed audio data, and the preprocessed audio data may comprise the transformed audio data. For example, the transformation function may comprise a multiplication of a vectored time series representation of the audio data with a transformation matrix. For example, the transformation function may comprise convolutions, audio filters (such as low-pass filters, high-pass filters, band-pass filters, all-pass filters, etc.), linear functions, nonlinear functions, and so forth. In some examples, the audio data may be preprocessed by smoothing the audio data, for example using Gaussian convolution, using a median filter, and so forth. In some examples, the audio data may be preprocessed to obtain a different representation of the audio data. For example, the preprocessed audio data may comprise: a representation of at least part of the audio data in a frequency domain; a Discrete Fourier Transform of at least part of the audio data; a Discrete Wavelet Transform of at least part of the audio data; a time/frequency representation of at least part of the audio data; a spectrogram of at least part of the audio data; a log spectrogram of at least part of the audio data; a Mel-Frequency Spectrum of at least part of the audio data; a sonogram of at least part of the audio data; a periodogram of at least part of the audio data; a representation of at least part of the audio data in a lower dimension; a lossy representation of at least part of the audio data; a lossless representation of at least part of the audio data; a time order series of any of the above; any combination of the above; and so forth. In some examples, the audio data may be preprocessed to extract audio features from the audio data. Some non-limiting examples of such audio features may include: auto-correlation; number of zero crossings of the audio signal; number of zero crossings of the audio signal centroid; MP3 based features; rhythm patterns; rhythm histograms; spectral features, such as spectral centroid, spectral spread, spectral skewness, spectral kurtosis, spectral slope, spectral decrease, spectral roll-off, spectral variation, etc.; harmonic features, such as fundamental frequency, noisiness, anharmonicity, harmonic spectral deviation, harmonic spectral variation, tristimulus, etc.; statistical spectrum descriptors; wavelet features; higher level features; perceptual features, such as total loudness, specific loudness, relative specific loudness, sharpness, spread, etc.; energy features, such as total energy, harmonic part energy, noise part energy, etc.; temporal features; and so forth. In some examples, analyzing the audio data may include calculating at least one convolution of at least a portion of the audio data, and using the calculated at least one convolution to calculate at least one resulting value and/or to make determinations, identifications, recognitions, classifications, and so forth.

In some embodiments, analyzing audio data (for example, by the methods, steps and modules described herein) may comprise analyzing the audio data and/or the preprocessed audio data using one or more rules, functions, procedures, artificial neural networks, speech recognition algorithms, speaker recognition algorithms, speaker diarization algorithms, audio segmentation algorithms, noise cancelling algorithms, source separation algorithms, inference models, and so forth. Some non-limiting examples of such inference models may include: an inference model preprogrammed manually; a classification model; a data regression model; a result of training algorithms, such as machine learning algorithms and/or deep learning algorithms, on training examples, where the training examples may include examples of data instances, and in some cases, a data instance may be labeled with a corresponding desired label and/or result; and so forth.

Some non-limiting examples of image data may include one or more images, grayscale images, color images, series of images, 2D images, 3D images, videos, 2D videos, 3D videos, frames, footages, or data derived from other image data. In some embodiments, analyzing image data (for example by the methods, steps and modules described herein) may comprise analyzing the image data to obtain a preprocessed image data, and subsequently analyzing the image data and/or the preprocessed image data to obtain the desired outcome. One of ordinary skill in the art will recognize that the followings are examples, and that the image data may be preprocessed using other kinds of preprocessing methods. In some examples, the image data may be preprocessed by transforming the image data using a transformation function to obtain a transformed image data, and the preprocessed image data may comprise the transformed image data. For example, the transformed image data may comprise one or more convolutions of the image data. For example, the transformation function may comprise one or more image filters, such as low-pass filters, high-pass filters, band-pass filters, all-pass filters, and so forth. In some examples, the transformation function may comprise a nonlinear function. In some examples, the image data may be preprocessed by smoothing at least parts of the image data, for example using Gaussian convolution, using a median filter, and so forth. In some examples, the image data may be preprocessed to obtain a different representation of the image data. For example, the preprocessed image data may comprise: a representation of at least part of the image data in a frequency domain; a Discrete Fourier Transform of at least part of the image data; a Discrete Wavelet Transform of at least part of the image data; a time/frequency representation of at least part of the image data; a representation of at least part of the image data in a lower dimension; a lossy representation of at least part of the image data; a lossless representation of at least part of the image data; a time ordered series of any of the above; any combination of the above; and so forth. In some examples, the image data may be preprocessed to extract edges, and the preprocessed image data may comprise information based on and/or related to the extracted edges. In some examples, the image data may be preprocessed to extract image features from the image data. Some non-limiting examples of such image features may comprise information based on and/or related to: edges; corners; blobs; ridges; Scale Invariant Feature Transform (SIFT) features; temporal features; and so forth. In some examples, analyzing the image data may include calculating at least one convolution of at least a portion of the image data, and using the calculated at least one convolution to calculate at least one resulting value and/or to make determinations, identifications, recognitions, classifications, and so forth.

In some embodiments, analyzing image data (for example by the methods, steps and modules described herein) may comprise analyzing the image data and/or the preprocessed image data using one or more rules, functions, procedures, artificial neural networks, object detection algorithms, face detection algorithms, visual event detection algorithms, action detection algorithms, motion detection algorithms, background subtraction algorithms, inference models, and so forth. Some non-limiting examples of such inference models may include: an inference model preprogrammed manually; a classification model; a regression model; a result of training algorithms, such as machine learning algorithms and/or deep learning algorithms, on training examples, where the training examples may include examples of data instances, and in some cases, a data instance may be labeled with a corresponding desired label and/or result; and so forth. In some embodiments, analyzing image data (for example by the methods, steps and modules described herein) may comprise analyzing pixels, voxels, point cloud, range data, etc. included in the image data.

A convolution may include a convolution of any dimension. A one-dimensional convolution is a function that transforms an original sequence of numbers to a transformed sequence of numbers. The one-dimensional convolution may be defined by a sequence of scalars. Each particular value in the transformed sequence of numbers may be determined by calculating a linear combination of values in a subsequence of the original sequence of numbers corresponding to the particular value. A result value of a calculated convolution may include any value in the transformed sequence of numbers. Likewise, an n-dimensional convolution is a function that transforms an original n-dimensional array to a transformed array. The n-dimensional convolution may be defined by an n-dimensional array of scalars (known as the kernel of the n-dimensional convolution). Each particular value in the transformed array may be determined by calculating a linear combination of values in an n-dimensional region of the original array corresponding to the particular value. A result value of a calculated convolution may include any value in the transformed array. In some examples, an image may comprise one or more components (such as color components, depth component, etc.), and each component may include a two dimensional array of pixel values. In one example, calculating a convolution of an image may include calculating a two dimensional convolution on one or more components of the image. In another example, calculating a convolution of an image may include stacking arrays from different components to create a three dimensional array, and calculating a three dimensional convolution on the resulting three dimensional array. In some examples, a video may comprise one or more components (such as color components, depth component, etc.), and each component may include a three dimensional array of pixel values (with two spatial axes and one temporal axis). In one example, calculating a convolution of a video may include calculating a three dimensional convolution on one or more components of the video. In another example, calculating a convolution of a video may include stacking arrays from different components to create a four dimensional array, and calculating a four dimensional convolution on the resulting four dimensional array. In some examples, audio data may comprise one or more channels, and each channel may include a stream or a one-dimensional array of values. In one example, calculating a convolution of audio data may include calculating a one dimensional convolution on one or more channels of the audio data. In another example, calculating a convolution of audio data may include stacking arrays from different channels to create a two dimensional array, and calculating a two dimensional convolution on the resulting two dimensional array.

Some non-limiting examples of a mathematical object in a mathematical space may include a mathematical point in the mathematical space, a group of mathematical points in the mathematical space (such as a region, a manifold, a mathematical subspace, etc.), a mathematical shape in the mathematical space, a numerical value, a vector, a matrix, a tensor, a function, and so forth. Another non-limiting example of a mathematical object is a vector, wherein the dimension of the vector may be at least two (for example, exactly two, exactly three, more than three, and so forth).

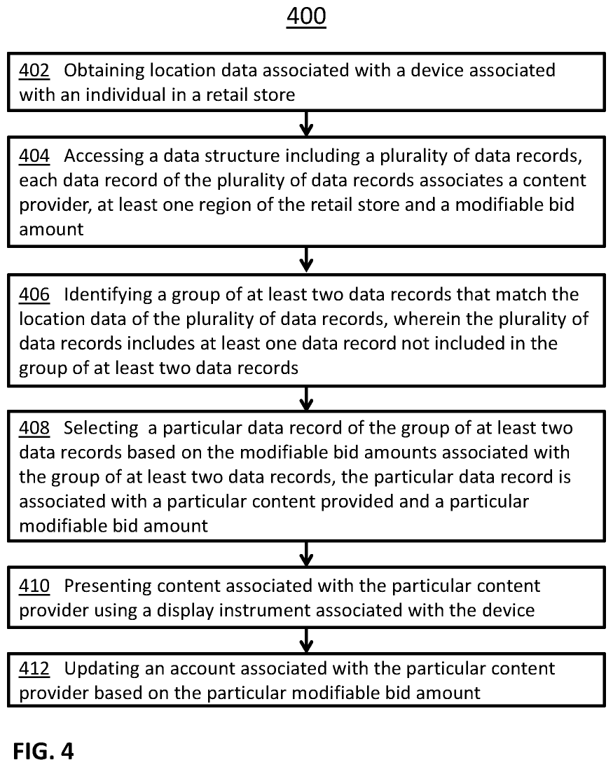

FIG. 4 is a flowchart of an exemplary method 400 for selecting content for presentation in retail stores, consistent with some embodiments of the present disclosure. In this example, method 400 may comprise obtaining location data associated with a device associated with an individual in a retail store (step 402); accessing a data structure including a plurality of data records, each data record of the plurality of data records associates a content provider, at least one region of the retail store and a modifiable bid amount (step 404); identifying a group of at least two data records that match the location data of the plurality of data records (step 406), wherein the plurality of data records includes at least one data record not included in the group of at least two data records; selecting a particular data record of the group of at least two data records based on the modifiable bid amounts associated with the group of at least two data records (step 408), the particular data record is associated with a particular content provided and a particular modifiable bid amount; presenting content associated with the particular content provider using a display instrument associated with the device (step 410); and updating an account associated with the particular content provider based on the particular modifiable bid amount (step 412). In other examples, method 400 may include additional steps or fewer steps. In other examples, one or more steps of method 400 may be executed in a different order and/or one or more groups of steps may be executed simultaneously. In some examples, the device may be a shopping cart associated with the individual. In other examples, the device may be at least one of a smartphone, a smart watch, a tablet, and so forth. In some examples, the device may be any mobile personal computing device associated with the individual. It is understood that herein, unless otherwise specified, any mention of a shopping cart is intended to encompass and be equally applicable to any mobile personal computing device associated with the individual.

In some examples, step 402 may comprise obtaining location data associated with a device associated with an individual (such as a shopping cart, a smartphone, a smart watch, a tablet, any mobile personal computing device, etc.) in a retail store. For example, the location data may be read from memory, may be received from an external computing device (for example, via a digital communication network), may be received from an individual (for example, via a user interface), may be determined based on an analysis of signals captured using a sensor (for example, a sensor included in the shopping cart, a sensor fixedly positioned in the retail store, etc.), and so forth. In one example, step 402 may capture the location data using an indoor positioning sensor associated with the device (for example, an indoor positioning sensor associated with the shopping cart, an indoor positioning sensor included in or mounted to the shopping cart, etc.). In some examples, step 402 may obtain image data captured using an image sensor associated with the device (for example, an image sensor associated with the shopping cart, an image sensor included in or mounted to the shopping cart, etc.). Further, step 402 may analyze the image data to obtain the location data, for example using a visual odometry algorithm. In some examples, step 402 may obtain image data captured using image sensors fixedly positioned in the retail store. Further, step 402 may analyze the image data to detect the device and/or the shopping cart and/or the individual in the image data, thereby obtaining the location data.

In some examples, step 404 may comprise accessing a data structure including a plurality of data records. Each data record of the plurality of data records may associate a content provider, at least one region of a retail store (for example, the retail store of step 402) and a modifiable bid amount. For example, the data structure may be accessed in a memory, may be accessed by communicating with an external computing device (for example, via a digital communication network), may be received from and/or created by and/or updated by an individual (for example, via a user interface), may be generated based on other information, and so forth. In one example, the data structure may be implemented using a database, for example by maintaining a table in the database, wherein each record in the table associates a content provider, at least one region of a retail store (for example, the retail store of step 402) and a modifiable bid amount. In one example, the data structure may associate a specific content provider with no data record, with a single data record, with a plurality of data records, and so forth. In one example, the data structure may associate a specific region with no data record, with a single data record, with a plurality of data records, and so forth. Two modifiable bid amounts of different data records of the data structure may be different or may be identical. In some examples, a modifiable bid amount (such as the modifiable bid amount of method 400 or method 620) may be a bid amount that may be modified, for example automatically, manually, by a different process, by an external computing device (for example, using a digital communication network), by an individual (for example, via a user interface), and so forth. In one example, a modifiable bid amount associated with a data record (such as the modifiable bid amount of method 400 or method 620) may be a bid amount that may be modified by a content provider associated with the data record, for example via a user interface, via a digital communication protocol, and so forth. In one example, a modifiable bid amount associated with a data record (such as the modifiable bid amount of method 400 or method 620) may be a bid amount that may be modified by one or more entities associated with the retail store. In one example, a modifiable bid amount associated with a data record (such as the modifiable bid amount of method 400 or method 620) may be a bid amount that may be modified by one or more entities not associated with the retail store. In one example, a modifiable bid amount associated with a data record (such as the modifiable bid amount of method 400 or method 620) may be a bid amount that may be automatically modified based on one or more rules, for example based on one or more rules set by a content provider associated with the data record. For example, the one or more rules may specify modifications and/or calculation of the modifiable bid amount based on at least one of customer journey data 100, location data 102, shopper data 104, data associated with other carts 106, shopping list 108, interactions data 110, retail store map 146, or retail store data 148.

In some examples, at least one region of the retail store (such as the at least one region of the retail store associated with at least one data record of the plurality of data records accessed by step 404) may be determined based on at least one of a product type, a product category or a brand. For example, a specific data record of the plurality of data records accessed by step 404 may associate at least one of a product type, a product category or a brand with a specific content provider and a specific modifiable bid amount, and thereby may indirectly associate the specific content provider and the specific modifiable bid amount with at least one region of the retail store based on the at least one of a product type, a product category or a brand. In one example, the at least one region may be determined based on a product type, such as ‘Roma Tomatoes’, for example by identifying a region of the retail store associated with the product type (such as a shelf associated with the product type and/or a region of an aisle adjacent to the shelf), for example based on retail store map 146. In one example, the at least one region may be determined based on a product category, such as ‘Dairy’, for example by identifying a region of the retail store associated with the product category (such as an aisle or a portion of an aisle), for example based on retail store map 146. In one example, the at least one region may be determined based on a brand, such as ‘Nestle’, for example by identifying a region of the retail store associated with the brand (such as shelves scattered in different regions of the retail store and/or regions of aisles adjacent to the shelves), for example based on retail store map 146.

In some examples, at least one region of the retail store (such as the at least one region of the retail store associated with at least one data record of the plurality of data records accessed by step 404) may be determined based on a distance from at least one of an entrance of the retail store or a point of sale of the retail store, for example based on retail store map 146. The distance may be calculated using different techniques, such as Euclidean distance, Manhattan distance, aerial distance, walking distance, and so forth.

In some examples, step 406 may comprise identifying a group of at least two data records that match location data (such as the location data obtained by step 402) of a plurality of data records (for example, of the plurality of data records of step 404). The plurality of data records may include at least one data record not included in the group of at least two data records. In some examples, step 406 may use a machine learning model to identify the group of at least two data records that match the location data. For example, step 406 may, for each data record of the plurality of data records, use a machine learning model to analyze the location data, the at least one region of the retail store associated with the respective data record and, optionally, additional information to determine whether to include or exclude the respective data record in the group of at least two data records. The machine learning model may be a machine learning model trained using training examples to determine whether location data matches regions. An example of such training example may include sample location data, at least one sample region and, optionally, sample additional information, together with a label indicating whether the sample location data matches the at least one sample region or not.

In some examples, a specific data record may match the location data when the location data indicates that the shopping cart is in the at least one region of the retail store associated with the specific data record. For example, the location data may be or include a position within the retail store, and step 406, for each data record of the plurality of data records, may determine geometrically whether the position is in the at least one region of the retail store associated with the respective data record, thereby determining whether the respective data record matches the location data.

In some examples, a specific data record may match the location data when the location data indicates that the shopping cart enters the at least one region of the retail store associated with the specific data record. In one example, the specific data record may not match the location data when the location data indicates that the shopping cart is within the at least one region of the retail store associated with the specific data record for more than a selected duration threshold (such as one second, less than one second, more than one second, etc.). In one example, the location data may be or include positions within the retail store at different points in time, and step 406, for each data record of the plurality of data records, may determine geometrically whether the positions indicates recent movement (for example, in the last threshold number of available position samples and/or within a selected duration threshold, such as one second, less than one second, more than one second, etc.) from outside the at least one region of the retail store associated with the respective data record to inside the at least one region, thereby determining whether the respective data record matches the location data.

In some examples, a specific data record may match the location data when the location data indicates that the shopping cart enters the at least one region of the retail store associated with the specific data record from a first direction, and the specific data record may not match the location data when the location data indicates that the shopping cart enters the at least one region of the retail store associated with the specific data record from a second direction. In one example, the location data may be or include a trajectory within the retail store, and step 406, for each data record of the plurality of data records, may determine geometrically a direction of entry to the at least one region of the retail store associated with the respective data record based on the trajectory. Further, step 406 may determine whether the respective data record matches the location data based on whether the current position is in the at least one region and/or on the direction of entry to the at least one region.

In some examples, a specific data record may match the location data when the location data indicates that the shopping cart leaves the at least one region of the retail store associated with the specific data record. In one example, the specific data record may not match the location data when the location data indicates that the shopping cart is within the at least one region of the retail store associated with the specific data record for more than a selected duration threshold (such as one second, less than one second, more than one second, etc.). In one example, the location data may be or include positions within the retail store at different points in time, and step 406, for each data record of the plurality of data records, may determine geometrically whether the positions indicates recent movement (for example, in the last threshold number of available position samples and/or within a selected duration threshold, such as one second, less than one second, more than one second, etc.) from inside the at least one region of the retail store associated with the respective data record to outside the at least one region, thereby determining whether the respective data record matches the location data.

In some examples, a specific data record may match the location data when the location data when the location data indicates that the shopping cart leaves the at least one region of the retail store associated with the specific data record in a first direction, and the specific data record may not match the location data when the location data indicates that the shopping cart leaves the at least one region of the retail store associated with the specific data record in a second direction. In one example, the location data may be or include a trajectory within the retail store, and step 406, for each data record of the plurality of data records, may determine a direction of an exit from the at least one region of the retail store associated with the respective data record geometrically based on the trajectory. Further, step 406 may determine whether the respective data record matches the location data based on the direction of the exit from the at least one region.

In some examples, step 406 may further base the identification of the group of at least two data records on a time duration, such as a time duration associated with an ongoing journey of the shopping cart in the retail store. Some non-limiting examples of a time duration associated with an ongoing journey of the shopping cart in the retail store may include a time duration since the ongoing journey started, a time duration since an event in the ongoing journey occurred, a time duration since the shopping cart was in or passed through a selected region of the retail store in the ongoing journey, a time duration between two events in the ongoing journey, a time duration between the moment the shopping cart passed through a first region of the retail store and a moment the shopping cart arrived at or passed through a second region of the retail store, a time duration which the shopping cart spend in a selected region of the retail store in the ongoing journey, and so forth. In one example, when the time duration is longer than a first selected threshold, step 406 may include a particular data record in the group of at least two data records, and/or when the time duration is shorter than a second selected threshold (that may be identical to or smaller than the first selected threshold), step 406 may exclude the particular data record from the group of at least two data records, or vice versa. In another example, step 406 may use the machine learning model as described above, where the time duration may be used as the additional information.

In some examples, step 406 may analyze the location data to identify a first mathematical object in a mathematical space, for example using module 302. Further, step 406 may, for each data record of the plurality of data records, analyze the at least one region of the retail store associated with the respective data record to obtain a mathematical object associated with the respective data record in the mathematical space, for example using module 304. Further, step 406 may base the identification of the group of at least two data records on the first mathematical object and the mathematical objects associated with the plurality of data records. For example, step 406 may select a region of the mathematical space based on the first mathematical object, and may include all data records corresponding to mathematical objects in the selected region of the mathematical space in the group of at least two data records. In another example, step 406 may select a region of the mathematical space based on the first mathematical object, and may exclude all data records corresponding to mathematical objects in the selected region of the mathematical space from the group of at least two data records. In some examples, the first mathematical object may define or be a particular region of the mathematical space, and selecting a region of the mathematical space based on the first mathematical object may comprise simply selecting the particular region. In some examples, the first mathematical object may be a point in the mathematical space, and selecting a region of the mathematical space based on the first mathematical object may comprise selecting a spherical region of a selected radius where the first mathematical object is the center of the spherical region.

In some examples, the location data may be or include an indication of whether the shopping cart returns to a particular region of the retail store after leaving the particular region. For example, the location data may be or include a trajectory, and may thereby indicate whether the shopping cart returns to the particular region of the retail store after leaving the particular region. Further, step 406 may base the identification of the group of at least two data records on the particular region and/or on whether the shopping cart returns to the particular region of the retail store after leaving the particular region. For example, step 406 may avoid including a particular data record when the shopping cart enters the at least one region associated with the particular data record for the first time in the ongoing customer journey, and may include the particular data record when the shopping cart returns to the at least one region after leaving it. In some examples, the location data may further include an indication of a time duration between the leaving the particular region and the returning to the particular region. For example, the location data may be or include positions within the retail store at different points in time, and may thereby indicate the time duration between the leaving the particular region and the returning to the particular region. Further, the identification of the group of at least two data records by step 406 may be further based on the time duration. For example, when the time duration meet a first criterion (for example, is shorter than a selected threshold, is longer than a selected threshold, is longer than a first selected threshold and shorter than a second selected threshold, and so forth), step 406 may include a particular data record in the group of at least two data records, and/or when the time duration meet a second criterion, step 406 may avoid including the particular data record in the group of at least two data records.

In some examples, step 408 may comprise selecting a particular data record of a group of at least two data records (for example, of the group of at least two data records identified by step 406, of the group of at least two data records identified by step 624, etc.) based on the modifiable bid amounts associated with the group of at least two data records. The particular data record may be associated with a particular content provided and a particular modifiable bid amount. For example, step 408 may select a particular data record that is associated with the highest modifiable bid amount of the modifiable bid amounts associated with the group of at least two data records. In another example, step 408 may select a particular data record that is associated with the lowest modifiable bid amount of the modifiable bid amounts associated with the group of at least two data records. In one example, step 408 may select a particular data record that is associated with the highest modifiable bid amount of the modifiable bid amounts associated with the group of at least two data records, and when two or more modifiable bid amounts of the modifiable bid amounts associated with the group of at least two data records have an identical highest value, step 408 may select one of them based on other criteria or randomly.

In some examples, step 410 may comprise presenting content (for example, content associated with a particular content provider, content associated with the particular content provider of step 408, etc.) using a display instrument (for example, a display instrument associated with a shopping cart, a display instrument associated with the device of step 402, a display instrument associated with a shopping cart, display screen 204, a display instrument of a personal device of an individual using the shopping cart, a display instrument fixedly positioned in the retail store, etc.). In some examples, the content presented by step 410 may be associated with the particular content provider. For example, step 410 may obtain the content associated with the particular content provider from the particular content provider. In another example, the data structure of step 404 may further associate each data record with a content associated with the respective content provider, and step 410 may access the data structure to obtain the content. In yet another example, step 410 may obtain the content associated with the particular content provider from available contents 142. In some examples, step 410 may generate and/or transmit digital information configured to cause the display instrument to present the content associated with the particular content provider. In some examples, step 410 may include a unique identifier (such as a file name, a network address, etc.) of the content in digital data (for example, in a HyperText Markup Language file) to cause the display instrument to present the content.

In some examples, step 412 may comprise updating an account (for example, an account associated with a particular content provider, an account associated with the particular content provider of step 408) based on a particular modifiable bid amount (for example, based on the particular modifiable bid amount of step 408). For example, step 412 may subtract the particular modifiable bid amount from a balance associated with the account. In another example, step 412 may record a transaction in the account, and may include an indication of the particular modifiable bid amount in the record. In one example, step 412 may update the account based on the particular modifiable bid amount in a memory, in a data structure, in a database, and so forth. In one example, step 412 may transmit digital signals to an external computing device to cause the external computing device to update the account based on the particular modifiable bid amount.

In some examples, the device of step 402 may be a shopping cart. Further, the location data obtained by step 402 may indicate a location of the shopping cart when at least one product is placed in the shopping cart. Further, each data record of the plurality of data records accessed by step 404 may be further associated with at least one of a product type, a product category or a brand. Further, each data record of the group of at least two data records identified by step 406 may match the at least one product (for example, the at least one product may be or include a product of the product type, the at least one product may be or include a product of the product category, the at least one product may be or include a product associated with the brand, and so forth). For example, step 406 may avoid including a particular data record in the group of at least two data records when the particular data record does not match the at least one product, and/or may include the particular data record in the group of at least two data records when the particular data record matches the at least one product.

In some examples, the location data obtained by step 402 may indicate a location of the shopping cart when the shopping cart is not advancing for at least a selected amount of time. Further, each data record of the group of at least two data records identified by step 406 may match the location of the shopping cart when the shopping cart is not advancing for at least the selected amount of time. For example, step 406 may identify data records that match the location of the shopping cart when the shopping cart is not advancing for at least the selected amount of time of the plurality of data records, thereby identifying the group of at least two data records.

In some examples, the location data obtained by step 402 may indicate a trajectory of the shopping cart in the retail store. Further, the identification of the group of at least two data records by step 406 may be based on the trajectory. For example, the trajectory may specify locations in the retail store, and the identification of the group of at least two data records by step 406 may be based on at least part of the specified locations, for example as described above. In another example, the trajectory may specify locations in the retail store arranged at a specified order, and the identification of the group of at least two data records by step 406 may be based on at least part of the specified locations and/or on the specified order.

In some examples, the location data obtained by step 402 may indicate a spatial orientation associated with the shopping cart. Further, the identification of the group of at least two data records by step 406 may be based on the spatial orientation. For example, the location data may specify a spatial orientation of the shopping cart at a specific location in the retail store and/or at a specific point in time. For example, step 406 may include a particular data record in the group of at least two data records when the spatial orientation is a first direction, and may exclude the particular data record from the group of at least two data records when the spatial orientation is a second direction. In one example, step 406 may use the machine learning model as described above, where the spatial orientation may be used as the additional information.

In some examples, method 400 may further comprise obtaining data associated with the individual of step 402 (for example, of an individual associated with a shopping cart, such as the shopping cart of step 402 and/or step 410, a different shopping cart, etc.), such as shopper data 104. For example, method 400 may use step 602 and/or step 604 to obtain the data associated with the individual. In another example, obtaining the data associated with individual may comprise reading the data from memory, receiving the data from an external computing device (for example, via a digital communication network), receiving the data from an individual (for example, via a user interface), determining the data based on an analysis of other information, and so forth. In some examples, the data associated with the individual may be or include demographic data associated with the individual, such as age, gender, ethnicity, religion, income level, education level, and so forth. In some examples, the data associated with the individual may be based on reactions of the individual to presentations made using the display instrument associated with the shopping cart. For example, the display instrument may be or include an input instrument (such as a touch screen, a keyboard, a microphone, a camera, etc.), and the data associated with the individual may be based on at least one of a selection made by the individual using the input instrument in response to the presentations, information provided by the individual using the input instrument in response to the presentations, a pace of interaction of the individual in response to the presentations, and so forth. In another example, the data associated with the individual may be based on movements of the shopping cart after the presentations. In some examples, the data associated with the individual may be based on inputs entered by the individual using a touch input instrument associated with the shopping cart. For example, based on selections made by the individual using the touch screen, based on information entered by the individual using the touch screen, and so forth. In some examples, a loyalty account associated with the individual may be used to obtain the data associated with the individual. In some examples, the data associated with the individual may be based on past purchases of the individual (for example, products purchased, quantities, prices, time of purchase, and so forth). In one example, the past purchases of the individual may be purchases from an ongoing journey of the individual in the retail store. For example, the shopping cart may be equipped with a product scanner, and the individual may scan the products while the ongoing journey continues. In another example, the past purchases of the individual may be purchases from at least one completed historic journey of the individual, for example, at least one completed historic journey of the individual in the retail store, at least one completed historic journey of the individual in a different retail store, at least one completed historic journey of the individual in a single retail store, at least one completed historic journey of the individual in at least two different retail stores, and so forth. In one example, a loyalty account associated with the individual may be used to obtain the purchases from the at least one completed historic journey of the individual. In another example, historic data may be used to analyze activities of the individual in an ongoing journey of the individual in the retail store to obtain the purchases from the at least one completed historic journey of the individual. For example, the individual may be identified based on activities and behavior in the ongoing journey, for example using pattern recognition algorithms, and the purchases from the at least one completed historic journey may be retrieved (for example, from a database, from memory, from a server, etc.) based on the identification of the individual. In some examples, the data associated with the individual may be based on a shopping list (that is, a list of purchases to be made) associated with the individual (such as shopping list 108), for example based on products and/or quantities in the shopping list. For example, the shopping list may be obtained from an external computing device, from an app for managing shopping lists, from the individual (for example, via a user interface), from an image of a handwritten shopping list, and so forth. In some examples, step 406 may further base the identification of the group of at least two data records on data associated with an individual (such as the data associated with the individual obtained as described above, data associated with the individual of step 402 and/or step 410, data associated with an individual associated with a different shopping cart, shopper data 104, and so forth). For example, step 406 may use the machine learning model as described above, where the data associated with the individual may be used as the additional information.

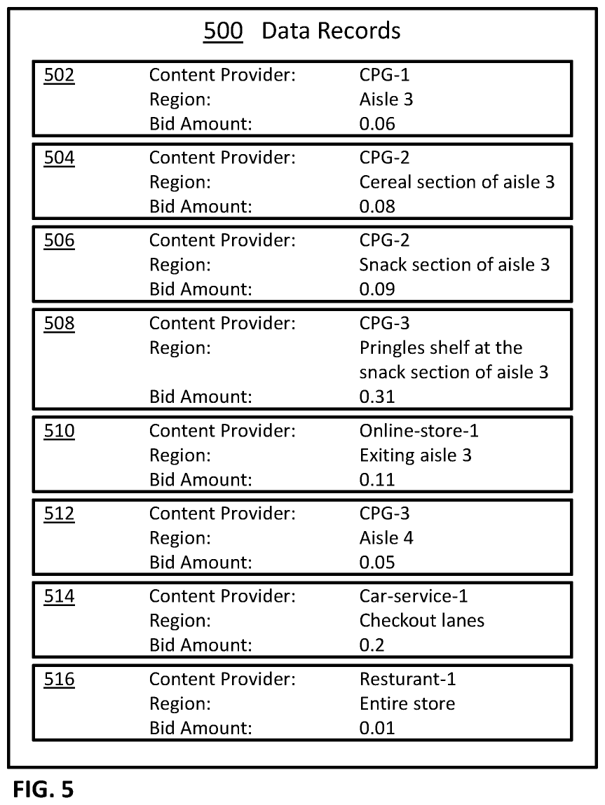

FIG. 5 is a block diagram illustrating data records 500, consistent with some embodiments of the present disclosure. Each data record of data records 500 may specify at least a content provider, a region of the retail store and a modifiable bid amount. In this example, data records 500 includes 8 data records. In some examples, step 404 may access data-structure containing data records 500 to obtain a plurality of data records that includes data records 502, 504, 506, 508, 510, 512, 514 and 516. In one example, when the location data obtained by step 402 indicates that the shopping cart is in aisle 3, but away from the snack section and the cereal section, step 406 may identify a group of data records that includes data records 502 and 516, step 408 may select, based on the modifiable bid amounts, data record 502 that associates content provider ‘CPG-1’ with bid amount 0.06, step 410 may present content associated with content provider ‘CPG-1’, and step 412 may update an account associated with content provider ‘CPG-1’ based on the modifiable bid amount of 0.06. In one example, when the location data obtained by step 402 indicates that the shopping cart is next to the snack section of aisle 3, but away from the Pringles shelf, step 406 may identify a group of data records that includes data records 502, 506 and 516, step 408 may select, based on the modifiable bid amounts, data record 506 that associates content provider ‘CPG-2’ with modifiable bid amount 0.09, step 410 may present content associated with content provider ‘CPG-2’, and step 412 may update an account associated with content provider ‘CPG-2’ based on the modifiable bid amount of 0.09. In one example, when the location data obtained by step 402 indicates that the shopping cart is next to the snack section of aisle 3 near the Pringles shelf, step 406 may identify a group of data records that includes data records 502, 506, 508 and 516, step 408 may select, based on the modifiable bid amounts, data record 508 that associates content provider ‘CPG-3’ with modifiable bid amount 0.31, step 410 may present content associated with content provider ‘CPG-3’, and step 412 may update an account associated with content provider ‘CPG-3’ based on the modifiable bid amount of 0.31. In one example, when the location data obtained by step 402 indicates that the shopping cart is existing aisle 3, step 406 may identify a group of data records that includes data records 510 and 516, step 408 may select, based on the modifiable bid amounts, data record 510 that associates content provider ‘Online-store-1’ with modifiable bid amount 0.11, step 410 may present content associated with content provider ‘Online-store-1’, and step 412 may update an account associated with content provider ‘Online-store-1’ based on the modifiable bid amount of 0.11. In one example, when the location data obtained by step 402 indicates that the shopping cart is in aisle 4, step 406 may identify a group of data records that includes data records 512 and 516, step 408 may select, based on the modifiable bid amounts, data record 512 that associates content provider ‘CPG-3’ with bid amount 0.05, step 410 may present content associated with content provider ‘CPG-3’, and step 412 may update an account associated with content provider ‘CPG-3’ based on the modifiable bid amount of 0.05. In one example, when the location data obtained by step 402 indicates that the shopping cart is in a checkout lane, step 406 may identify a group of data records that includes data records 514 and 516, step 408 may select, based on the modifiable bid amounts, data record 514 that associates content provider ‘Car-service-1’ with bid amount 0.2, step 410 may present content associated with content provider ‘Car-service-1’, and step 412 may update an account associated with content provider ‘Car-service-1’ based on the modifiable bid amount of 0.2.

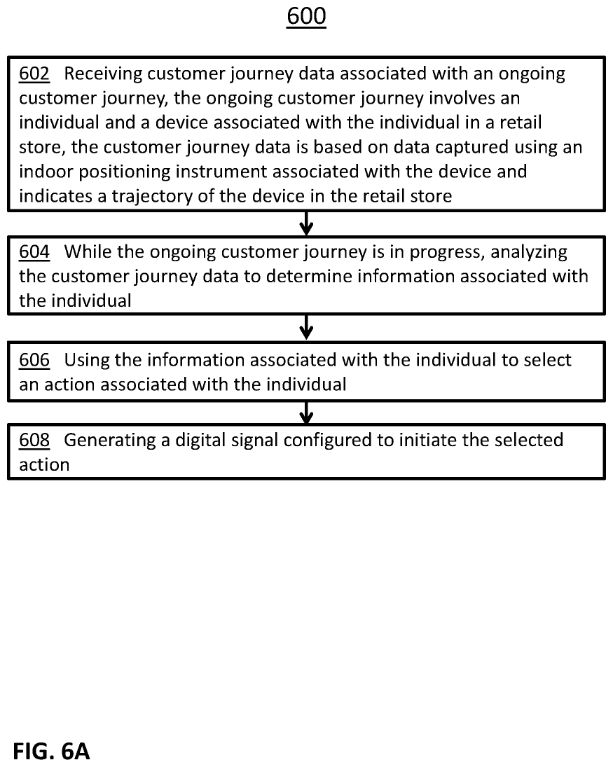

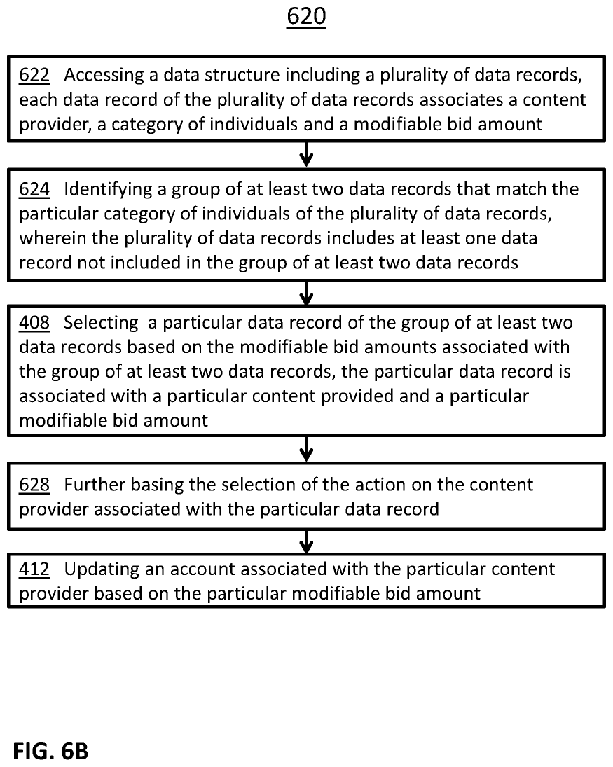

FIG. 6A is a flowchart of an exemplary method 600 for initiating actions based on ongoing customer journeys, consistent with some embodiments of the present disclosure. In this example, method 600 may comprise receiving customer journey data associated with an ongoing customer journey (step 602), the ongoing customer journey may involve an individual and a device associated with the individual in a retail store, the customer journey data may be based on data captured using an indoor positioning instrument associated with the device and may indicate a trajectory of the device in the retail store; while the ongoing customer journey is in progress, analyzing the customer journey data to determine information associated with the individual (step 604); using the information associated with the individual to select an action associated with the individual (step 606); and generating a digital signal configured to initiate the selected action (step 608). In other examples, method 600 may include additional steps or fewer steps. In other examples, one or more steps of method 600 may be executed in a different order and/or one or more groups of steps may be executed simultaneously. In some examples, the device may be a shopping cart associated with the individual. In other examples, the device may be at least one of a smartphone, a smart watch, a tablet, and so forth. In some examples, the device may be any mobile personal computing device associated with the individual. It is understood that herein, unless otherwise specified, any mention of a shopping cart is intended to encompass and be equally applicable to any mobile personal computing device associated with the individual.

In some examples, step 602 may comprise receiving customer journey data associated with an ongoing customer journey. The ongoing customer journey may involve an individual and a device associated with the individual (such as, a shopping cart associated with the individual, any mobile personal computing device associated with the individual, etc.) in a retail store. The customer journey data may be based, at least in part, on data captured using an indoor positioning instrument associated with the device (for example, associated with the shopping cart). Further, the customer journey data may indicate a trajectory of the device (for example, of the shopping cart) in the retail store. For example, step 602 may use step 402 to obtain location data associated with the ongoing customer journey, thereby obtaining the customer journey data. In another example, the customer journey data associated with the ongoing customer journey may be customer journey data 100. In one example, step 602 may read the customer journey data from memory, may receive the customer journey data from an external computing device (for example, via a digital communication network), may receive the customer journey data from an individual (for example, via a user interface), may determine the customer journey data based on an analysis of other information (such as images and/or sounds captured using sensors associated with the shopping cart, a shopping list, shopper data of the individual, etc.), may capture the customer journey data (for example, using the indoor positioning instrument associated with the shopping cart), and so forth.

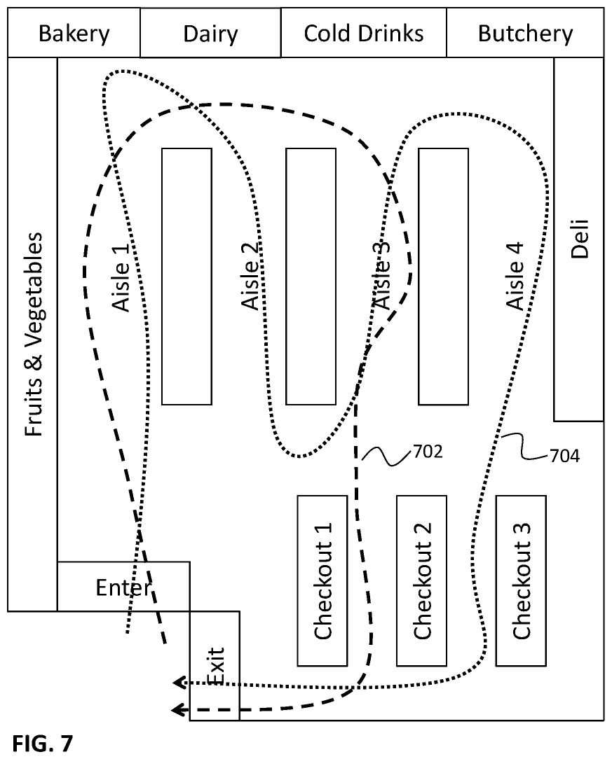

In some examples, step 604 may comprise, while the ongoing customer journey is in progress, analyzing customer journey data (such as the customer journey data received by step 602) to determine information associated with an individual (such as the individual of step 602). For example, step 604 may use a machine learning model to analyze the customer journey data to determine the information associated with the individual. The machine learning model may be a machine learning model trained using training examples to determine data associated with individuals based on customer journey information and/or additional information. An example of such training example may include sample customer journey data and/or sample additional information, together with a label indicative of information associated with a sample individual associated with the sample customer journey data. In one example, step 604 may base the determination of the information associated with the individual, at least in part, on a trajectory of a shopping cart in a retail store indicated by the customer journey data, for example as described below in relation to FIG. 7.

In some examples, the information associated with the individual determined by step 604 may be further based on a profile associated with the individual (such as shopper data 104). In one example, the selection of the action by step 606 may be based, at least in part, on the profile associated with the individual, for example through the information associated with the individual determined by step 604. In one example, step 604 may analyze the customer journey data and the profile to determine the information associated with the individual. For example, step 604 may use the machine learning model as described above, where the profile associated with the individual may be used as the additional information. In one example, the profile may indicate at least one demographic characteristic associated with the individual (such as age, gender, ethnicity, income level, employment status, marital status, etc.), and step 604 may base the determination of the information associated with the individual on the at least one demographic characteristic, for example by including the at least one demographic characteristic in the determined information associated with the individual. In some examples, the profile may be based on inputs entered by the individual using a touch input instrument associated with the shopping cart, and step 604 may base the determination of the information associated with the individual on inputs. In some examples, the profile may be based on a shopping list associated with the individual (such as shopping list 108), and step 604 may base the determination of the information associated with the individual on information included in the shopping list (for example, on product types and/or quantities from the shopping list). In one example, a handwritten version of the shopping list may be received (for example, an image of the handwritten version of the shopping list may be received and/or captured), the handwritten version may be analyzed to obtain a digital version of the shopping list (for example, using an Optical Character Recognition algorithm, using a multimodal LLM, etc.), and the profile may be further based on at least one of shapes of characters in the handwritten version, sizes of characters in the handwritten version, spacing between characters in the handwritten version, spacing between words in the handwritten version, or spacing between lines in the handwritten version. In some examples, the profile may be based on reactions of the individual to presentations made using the display instrument associated with the shopping cart. For example, the display instrument may be or include an input instrument (such as a touch screen, a keyboard, a microphone, a camera, etc.), and the profile may be based on at least one of a selection made by the individual using the input instrument in response to the presentations, information provided by the individual using the input instrument in response to the presentations, a pace of interaction of the individual in response to the presentations, and so forth. In another example, the profile may be based on movements of the shopping cart after the presentations. In one example, the profile may be based on a pace associated with the reactions. In some examples, the profile may be based on past purchases of the individual from at least one completed historic journey of the individual (for example, at least one completed historic journey of the individual in the retail store, at least one completed historic journey of the individual in a different retail store, at least one completed historic journey of the individual in a single retail store, at least one completed historic journey of the individual in at least two retail stores, and so forth). For example, the profile may be based on at least one of product types, quantities or time of sale of the past purchases of the individual. In one example, historic data may be used to analyze activities of the individual in the ongoing customer journey to obtain the purchases from the at least one completed historic journey of the individual, for example as described above. In one example, a loyalty account associated with the individual may be used to obtain the purchases from the at least one completed historic journey of the individual.

In some examples, step 606 may comprise using information associated with an individual (such as the information associated with the individual determined by step 604) to select an action, for example to select an action associated with the individual. In one example, step 606 may use a machine learning model to analyze the information associated with the individual to select the action associated with the individual. The machine learning model may be a machine learning model trained using training examples to select actions based on information. An example of such training example may include sample data associated with a sample individual, together with a label indicative of a sample selection of a sample action associated with the sample individual. In some examples, step 606 may base the selection of the action associated with the individual, at least in part, on a trajectory of a shopping cart in a retail store indicated by a customer journey data associated with the individual, for example as described below in relation to FIG. 7.

In some examples, step 604 may analyze the customer journey data to predict a prospective purchase of the individual, for example in the ongoing customer journey, in a prospective customer journey of the individual, and so forth. In some examples, the information associated with the individual determined by step 604 may be based on the predicted prospective purchase of the individual (for example, on a product type or quantity associated with the predicted prospective purchase). For example, the information associated with the individual determined by step 604 may be indicative of the predicted prospective purchase. In one example, step 604 may use the machine learning model as described above, where the predicted prospective purchase may be used as the additional information. In some examples, step 606 may base the selection of the action, at least in part, on the predicted prospective purchase, for example through the information associated with the individual determined by step 604. For example, the action may include providing a coupon associated with either a product associated with the predicted prospective purchase or with a product competing with the product associated with the predicted prospective purchase. In another example, the action may include providing navigational recommendation based on a location of products associated with the predicted prospective purchase in the retail store. In yet another example, the action may include providing promotional content associated with either a product associated with the predicted prospective purchase or with a product competing with the product associated with the predicted prospective purchase. In some examples, a machine learning model may be used to analyze customer journey data to predict the prospective purchase of the individual. The machine learning model may be a machine learning model trained using training examples to determine prospective purchases based on ongoing customer journeys. An example of such training example may include information of a sample part of a sample customer journey, together with a label indicative of a purchase in the sample customer journey taking place after the sample part. In some examples, the customer journey data may be analyzed to determine a confidence level associated with the prediction. For example, a machine learning model may be used to analyze customer journey data to predict the prospective purchase of the individual, as described above, and the machine learning model may be a machine learning model configured to output confidence level along with the prediction. Further, step 606 may further base the selection of the action on the confidence level associated with the predicted prospective purchase. For example, when the confidence level is above a selected threshold, step 606 may base the selection of the action on the predicted prospective purchase, and when the confidence level is below the selected threshold, step 606 may avoid basing the selection of the action on the predicted prospective purchase.

In some examples, step 604 may analyze the customer journey data to predict a susceptibility of the individual to a recommendation. Further, the information associated with the individual determined by step 604 may be based on the predicted susceptibility of the individual to the recommendation. For example, the information associated with the individual determined by step 604 may be indicative of the susceptibility of the individual to the recommendation. In one example, step 604 may use the machine learning model as described above, where the susceptibility of the individual to the recommendation may be used as the additional information. In one example, the selection of the action by step 606 may be based, at least in part, on the susceptibility of the individual to the recommendation, for example through the information associated with the individual determined by step 604. In some examples, a machine learning model may be used to analyze customer journey data to predict the susceptibility of the individual to the recommendation. The machine learning model may be a machine learning model trained using training examples to determine susceptibility of individuals to recommendations in ongoing customer journeys. An example of such training example may include information of a sample part of a sample customer journey, a sample recommendation and an indication of a sample individual, together with a label indicative of a susceptibility of the sample individual to the sample recommendation in the sample customer journey when the sample recommendation is provided after the sample part. In some examples, the information associated with the individual may be indicative of a susceptibility of the individual to a recommendation, for example as described above, and step 606 may base the selection of the action on the susceptibility of the individual to the recommendation. For example, when the susceptibility of the individual to the recommendation is high, the action selected by step 606 may be or include providing the recommendation, and when the susceptibility of the individual to the recommendation is low, the action selected by step 606 may include providing a different recommendation.

In some examples, a customer journey data (such as the customer journey data received by step 602, customer journey data 100, etc.) may further indicate stops of the shopping cart during the ongoing customer journey. Further, the information associated with the individual determined by step 604 may be based on the stops of the shopping cart during the ongoing customer journey, for example, based on locations and/or durations of the stops. In one example, step 604 may use the machine learning model as described above, where information associated with the stops of the shopping cart during the ongoing customer journey may be used as the additional information. In one example, the selection of the action by step 606 may be based, at least in part, on the stops of the shopping cart during the ongoing customer journey, for example through the information associated with the individual determined by step 604. For example, when the shopping cart stops at a specific region of the retail store during the ongoing customer journey, step 606 may select a first action, and when the shopping cart does not stop at the specific region of the retail store during the ongoing customer journey, step 606 may select a second action, where the second action may differ from the first action. In another example, when the shopping cart stops at a specific region of the retail store during the ongoing customer journey for a duration longer than a selected duration threshold, step 606 may select a first action, and when the shopping cart stops at the specific region of the retail store during the ongoing customer journey for a duration shorter than the selected duration threshold, step 606 may select a second action, where the second action may differ from the first action.

In some examples, a customer journey data (such as the customer journey data received by step 602, customer journey data 100, etc.) may further indicate purchases made by the individual during the ongoing customer journey. Further, the information associated with the individual determined by step 604 may be based on the purchases made by the individual during the ongoing customer journey, for example, based on time of purchase, based on product purchased, based on quantity of purchased items, based on price of purchased items, and so forth. In one example, step 604 may use the machine learning model as described above, where information associated with the purchases may be used as the additional information. In one example, the selection of the action by step 606 may be based, at least in part, on the purchases, for example through the information associated with the individual determined by step 604. For example, when the purchases include a purchase of a product of a particular product type, step 606 may select a first action, and when the purchases include no purchase of a product of the particular product type, step 606 may select a second action, where the second action may differ from the first action.

In some examples, a customer journey data (such as the customer journey data received by step 602, customer journey data 100, etc.) may further indicate content presented to the individual using an instrument associated with the shopping cart during the ongoing customer journey. Further, the information associated with the individual determined by step 604 may be based on the content presented to the individual, for example based on the content items presented, based on the time of presentation, based on the length of presentation, and so forth. In one example, step 604 may use the machine learning model as described above, where information associated with the content presented to the individual may be used as the additional information. In one example, the selection of the action by step 606 may be based, at least in part, on the content presented to the individual, for example through the information associated with the individual determined by step 604. For example, when a first content was presented to the individual, step 606 may select a first action, and when the first content was not presented to the individual, step 606 may select a second action, where the second action may differ from the first action.

In some examples, a customer journey data (such as the customer journey data received by step 602, customer journey data 100, etc.) may further indicate inputs entered by the individual using an instrument associated with the shopping cart during the ongoing customer journey. Further, the information associated with the individual determined by step 604 may be based on the inputs entered by the individual, for example based on the content of the inputs, based on the timing of the inputs, based on selections made by the user through the inputs, and so forth. In one example, step 604 may use the machine learning model as described above, where information associated with the inputs entered by the individual may be used as the additional information. In one example, the selection of the action by step 606 may be based, at least in part, on the inputs entered by the individual, for example through the information associated with the individual determined by step 604. For example, when the inputs entered by the individual include a particular input, step 606 may select a first action, and when the inputs entered by the individual do not include the particular input, step 606 may select a second action, where the second action may differ from the first action.

In some examples, a customer journey data (such as the customer journey data received by step 602, customer journey data 100, etc.) may include time series data, such as locations of the shopping cart at different points in times, acceleration of the shopping cart at different points in times, and so forth. Further, the information associated with the individual determined by step 604 may be based on the time series data. In one example, step 604 may use the machine learning model as described above, where the time series data may be used as the additional information. In one example, the selection of the action by step 606 may be based, at least in part, on the time series data, for example through the information associated with the individual determined by step 604. In one example, a convolution of at least part of the time series data may be calculated to obtain a numerical result value. Further, step 604 may base the information associated with the individual, at least in part, on the numerical result value. Further step 606 may base the selection of the action, at least in part, on the numerical result value, for example through the information associated with the individual determined by step 604. For example, when the numerical result value is a first numerical value, step 606 may select a first action, and when the numerical result value is a second numerical value, step 606 may select a second action, where the second action may differ from the first action.

In some examples, a customer journey data (such as the customer journey data received by step 602, customer journey data 100, etc.) may further include an indication of whether the shopping cart returns to a particular region of the retail store after leaving the particular region. Further, the determination of the information associated with the individual by step 604 may be based on the particular region and/or on whether the shopping cart returns to the particular region of the retail store after leaving the particular region. In one example, step 604 may use the machine learning model as described above, where the particular region of the retail store and/or an indication of whether the shopping cart returns to the particular region of the retail store after leaving the particular region may be used as the additional information. In one example, the selection of the action by step 606 may be based, at least in part, on the particular region and/or on whether the shopping cart returns to the particular region of the retail store after leaving the particular region, for example through the information associated with the individual determined by step 604. For example, when the shopping cart returns to the particular region of the retail store after leaving the particular region, step 606 may select a first action, and when the shopping cart does not return to the particular region of the retail store after leaving the particular region, step 606 may select a second action, where the second action may differ from the first action. In some examples, the customer journey data may further include an indication of a time duration between the leaving the particular region and the returning to the particular region. Further, the determination of the information associated with the individual by step 604 may be further based on the time duration. In one example, step 604 may use the machine learning model as described above, where the time duration may be used as the additional information. In one example, the selection of the action by step 606 may be based, at least in part, on the particular region and/or on whether the shopping cart returns to the particular region of the retail store after leaving the particular region and/or on the time duration, for example through the information associated with the individual determined by step 604. For example, when the shopping cart returns to the particular region of the retail store after leaving the particular region in less than a selected time duration threshold, step 606 may select a first action, and when the shopping cart returns to the particular region of the retail store after leaving the particular region only after the selected time duration threshold, step 606 may select a second action, where the second action may differ from the first action.

In some examples, step 608 may comprise generating a digital signal configured to initiate a selected action (such as the action selected by step 606, a preselected action, etc.). For example, step 608 may generate the digital signal while the ongoing customer journey is in progress. In another example, step 608 may generate the digital signal after the ongoing customer journey is completed. In one example, the digital signal may be configured to initiate the selected action while the ongoing customer journey is in progress. In another example, the digital signal may be configured to initiate the selected action after the ongoing customer journey is completed. In one example, step 608 may encode in the digital signal at least one of an identifier of the selected action, one or more parameters of the selected action, or one or more instructions that when executed by at least one processor causes the at least one processor to perform the selected action. In one example, step 608 may store the generated digital signal in memory, may transmit the generated digital signal to an external computing device, and so forth. In one example, method 600 may further comprise using the generated digital signal to initiate the selected action. In one example, step 608 may transmit the generated digital signal to a computing device associated with the shopping cart to cause the computing device to initiate the selected action. For example, the generated digital signal may include instructions for the computing device associated with the shopping cart for causing the computing device to initiate the action (for example, to present information, to update a record, etc.). In another example, the generated digital signal may include information for presentation by the computing device associated with the shopping cart.

In some examples, a selected action (such as the action selected by step 606 and/or the selected action of step 608) may include presenting a particular content to the individual using a display instrument associated with the shopping cart, for example while the ongoing customer journey is in progress. Further, method 600 may further comprise, alternatively or additionally to step 606, selecting the particular content based on information associated with an individual (such as the information associated with the individual determined by step 604). In one example, method 620 may be used to select the particular content based on a category of individuals indicated by the information associated with the individual, for example as described below. In another example, a machine learning model may be used to analyze the information associated with the individual to select the particular content. The machine learning model may be a machine learning model trained to select content items for presentation based on information associated with individuals. An example of such training example may include sample information associated with a sample individual, together with a label indicative of a sample selection of a sample content item for presentation to the sample individual.

In some examples, method 600 may further comprise, alternatively or additionally to step 606, analyzing information associated with an individual (such as the information associated with the individual determined by step 604) to obtain particular data. Further, the action selected by step 606 and/or the action of step 608 may include usage of the particular data. For example, the action may include displaying the particular data using a display instrument associated with the shopping cart. In another example, the action may include updating a profile associated with the individual based on the particular data, for example as described below.

In some examples, a selected action (such as the action selected by step 606 and/or the selected action of step 608) may include updating a profile (such as shopper data 104) associated with an individual (such as the individual of step 602 and/or step 604 and/or step 606, a different individual, etc.), for example while the ongoing customer journey is in progress or after the ongoing customer journey is completed. Further, the update may be based on information associated with the individual (such as the information associated with the individual determined by step 604). For example, method 600 may further comprise, alternatively or additionally to step 606, determining an update to a profile associated with the individual based on the information associated with the individual, for example, using one or more update rules, using an update function, using a state-machine, and so forth.

In some examples, a selected action (such as the action selected by step 606 and/or the selected action of step 608) may include offering, while the ongoing customer journey is in progress, an online purchase opportunity to the individual. The online purchase opportunity may be associated with a delivery of a selected product from a first destination to a second destination without passing through the retail store. In one example, method 600 may further comprise, alternatively or additionally to step 606, analyzing the information associated with the individual to select at least one of a product type or a price associated with the selected product. For example, a machine learning model may be used to analyze the information associated with the individual to select the at least one of a product type or a price associated with the selected product. The machine learning model may be a machine learning model trained using training examples to select product types and/or prices based on information associated with individuals. An example of such training example may include sample information associated with a sample individual, together with a label indicative of a selection of a sample product type and/or a sample price.

In some examples, step 604 may analyze the customer journey data to classify the individual to a particular category of individuals, for example using a classification algorithm. Further, the information associated with the individual determined by step 604 may be based on the classification of the individual to the particular category of individuals. For example, the information associated with the individual determined by step 604 may be indicative of the particular category of individuals. In one example, step 604 may use the machine learning model as described above, where the particular category of individuals may be used as the additional information. In one example, the selection of the action by step 606 may be based, at least in part, on the particular category of individuals, for example through the information associated with the individual determined by step 604. In one example, step 606 may base the selection of the action on the particular category of individuals. For example, when the particular category of individuals is a first category, the action selected by step 606 may be a first action, and when the particular category of individuals is a second category, the action selected by step 606 may be a second action. The second action may differ from the first action. In some examples, step 606 may use method 620 to select the action based on the particular category of individuals.

FIG. 6B is a flowchart of an exemplary method 620 for initiating actions based on ongoing customer journeys, consistent with some embodiments of the present disclosure. In this example, method 600 may comprise accessing a data structure including a plurality of data records, each data record of the plurality of data records associates a content provider, a category of individuals and a modifiable bid amount (step 622); identifying a group of at least two data records that match the particular category of individuals of the plurality of data records, wherein the plurality of data records includes at least one data record not included in the group of at least two data records (step 624); selecting a particular data record of the group of at least two data records based on the modifiable bid amounts associated with the group of at least two data records, the particular data record is associated with a particular content provided and a particular modifiable bid amount (step 408); further basing the selection of the action on the content provider associated with the particular data record (step 628); and updating an account associated with the particular content provider based on the particular modifiable bid amount (step 412). In other examples, method 620 may include additional steps or fewer steps. In other examples, one or more steps of method 620 may be executed in a different order and/or one or more groups of steps may be executed simultaneously.

In some examples, step 622 may comprise accessing a data structure including a plurality of data records. Each data record of the plurality of data records may associate a content provider, a category of individuals and a modifiable bid amount. For example, the data structure may be accessed in a memory, may be accessed by communicating with an external computing device (for example, via a digital communication network), may be received from and/or created by and/or updated by an individual (for example, via a user interface), may be generated based on other information, and so forth. In one example, the data structure may be implemented using a database, for example by maintaining a table in the database, wherein each record in the table associates a content provider, a category of individuals, and a modifiable bid amount. In one example, the data structure may associate a specific content provider with no data record, with a single data record, with a plurality of data records, and so forth. In one example, the data structure may associate a specific category of individuals with no data record, with a single data record, with a plurality of data records, and so forth. Two modifiable bid amounts of different data records of the data structure may be different or may be identical. In some examples, a modifiable bid amount may be a bid amount that may be modified, for example automatically, manually, by a different process, by an external computing device (for example, using a digital communication network), by an individual (for example, via a user interface), and so forth. In one example, a modifiable bid amount associated with a data record may be a bid amount that may be modified by a content provider associated with the data record, for example via a user interface, via a digital communication protocol, and so forth. In one example, a modifiable bid amount associated with a data record may be a bid amount that may be automatically modified based on one or more rules set by a content provider associated with the data record. For example, the one or more rules may specify modifications and/or calculation of the modifiable bid amount based on at least one of customer journey data 100, location data 102, shopper data 104, data associated with other carts 106, shopping list 108, interactions data 110, retail store map 146, or retail store data 148.

In some examples, step 624 may comprise identifying a group of at least two data records that match a particular category of individuals (for example, a particular category of individuals determined by step 604 as described above, a particular category of individuals otherwise received, etc.) of a plurality of data records (for example, of the plurality of data records accessed by step 622). The plurality of data records may include at least one data record not included in the group of at least two data records identified by step 624. For example, an indication of the particular category of individuals may be determined by step 604 as described above, may be read from memory, may be received from an external computing device (for example, via a digital communication network), may be received from an individual (for example, via a user interface), and so forth.

In some examples, step 628 may comprise further basing the selection of the action on a content provider (for example, on the content provider associated with the particular data record selected by step 408). In one example, the selected action may comprise presenting content associated with the content provider using a display instrument (for example, a display instrument associated with a shopping cart, a display instrument associated with the device of step 602, a display instrument associated with a shopping cart, display screen 204, a display instrument of a personal device of an individual using the shopping cart, a display instrument fixedly positioned in the retail store, etc.).

In some examples, the information associated with the individual determined by step 604 may be or include a mathematical object in a mathematical space. For example, the customer journey data received by step 602 may indicate or include location data, as described above, and step 604 may use module 302 to analyze the location data and obtain the mathematical object. In another example, the customer journey data received by step 602 may indicate a region of the retail store where the individual spent a significant amount of time, and step 604 may use module 304 to identify the mathematical object based on the region of the retail store. Further, step 606 may use the mathematical object to select the action associated with the individual. For example, when the mathematical object is a first object, step 606 may select a first action, and when the mathematical object is a second object, step 606 may select a second action, where the second action may differ from the first action. In some examples, the information associated with the individual determined by step 604 may be or include a plurality of mathematical objects in a mathematical space. Further, step 606 may calculate a mathematical function of the plurality of mathematical objects to obtain a numerical result value. Some non-limiting examples of such function may include a linear function, a non-linear function, a polynomial function, an exponential function, a logarithmic function, a continuous function, a discontinuous function, and so forth. Further, step 606 may base the selection of the action associated with the individual on the numerical result value. For example, when the numerical result value is a first numerical value, step 606 may select a first action, and when the numerical result value is a second numerical value, step 606 may select a second action, where the second action may differ from the first action.

In some examples, the information associated with the individual may be or include the customer journey data. Therefore, it is understood that, unless otherwise specified, any analysis of the information associated with the individual may be equally an analysis of the customer journey data, and that any result (such as determination, selection, etc.) based on the information associated with the individual may be equally based on the customer journey data. For example, step 604 may be excluded from method 600, and while the ongoing customer journey is in progress, step 606 may analyze the customer journey data to select the action associated with the individual.

In some examples, the information associated with the individual may be or include an indication of a selection of an action associated with the individual. Therefore, it is understood that the determination of the information associated with the individual may be equally a selection of the action associated with the individual. For example, step 606 may be excluded from method 600, and while the ongoing customer journey is in progress, step 604 may analyze the customer journey data to select the action associated with the individual.

FIG. 7 is a block diagram illustrating two different customer journeys, 702 and 704, over a floorplan of a retail store, consistent with some embodiments of the present disclosure. In this example, the retail store may include different sections (such as ‘Fruits & Vegetables’, ‘Bakery’, ‘Dairy’, ‘Cold Drinks’, ‘Butchery’, ‘Deli’, ‘Aisle 1’, ‘Aisle 2’, ‘Aisle 3’, ‘Aisle 4’, ‘Checkout 1’, ‘Checkout 2’ and/or ‘Checkout 3’). In this example, customer journey 702 may include entering the retail store, passing through ‘Aisle 1’, then going directly to ‘Aisle 3’ without passing through ‘Aisle 2’, and after passing through ‘Aisle 3’, going to ‘Checkout 1’ and from there, exiting the retail store. In this example, customer journey 704 may include entering the retail store, passing through ‘Aisle 1’, then stopping at the ‘Bakery’, then passing through ‘Aisle 2’, then passing through ‘Aisle 3’, then stopping at the ‘Deli’ while passing through ‘Aisle 4’ to ‘Checkout 2’, and from there exiting the retail store. In one example, 602 may receive data associated with customer journey 702 while customer journey 702 is ongoing. Further, steps 604, 606 and 608 may cause a presentation of a first content item via a display screen associated with a shopping cart associated with customer journey 702 while the shopping cart is in ‘Aisle 3’. In another example, 602 may receive data associated with customer journey 704 while customer journey 704 is ongoing. Further, steps 604, 606 and 608 may cause a presentation of a second content item via a display screen associated with a shopping cart associated with customer journey 704 while the shopping cart is in ‘Aisle 3’. The first and second content items may be selected based on the respective customer journey. For example, based on the stop at the ‘Bakery’ in customer journey 704, step 604 may identify a likely interest in bread spreads, and based on the passing through ‘Aisle 2’ that is dedicated to baby product in customer journey 704, step 604 may identify a likely interest in parenting strategies. Therefore, step 606 may select the second content item to be a coupon for a specific sandwich spread positioned in ‘Aisle 3’ and a coupon for a book about parenting strategies that is positioned in a book section in ‘Aisle 3’. In another example, based on the skipping of the ‘Bakery’ and ‘Aisle 2’ in customer journey 702, step 604 may identify a lack of interest in baby products and sandwich spreads, and step 606 may therefore avoid including a coupon to the book about parenting strategies in the first content item, and may include a coupon for a different book that is positioned in a book section in ‘Aisle 3’ in the first content item. Further, step 606 may therefore avoid including the coupon for the specific sandwich spread in the first content item, and may include a coupon for a frozen meal positioned in ‘Aisle 3’ in the first content item.

What is claimed is:

1. A non-transitory computer readable medium storing a software program comprising data and computer implementable instructions that when executed by at least one processor cause the at least one processor to perform operations for initiating actions based on ongoing customer journeys, the operations comprising:
receiving customer journey data associated with an ongoing customer journey, the ongoing customer journey involves an individual and a device associated with the individual in a retail store, the customer journey data is based on data captured using an indoor positioning instrument associated with the device and indicates a trajectory of the device in the retail store;
while the ongoing customer journey is in progress, analyzing the customer journey data to determine information associated with the individual;
using the information associated with the individual to select an action associated with the individual; and
generating a digital signal configured to initiate the selected action.

2. The non-transitory computer readable medium of claim 1, wherein the device is a shopping cart.

3. The non-transitory computer readable medium of claim 1, wherein the information associated with the individual is further based on a profile associated with the individual, and wherein the profile indicates at least one demographic characteristic associated with the individual.

4. The non-transitory computer readable medium of claim 1, wherein the information associated with the individual is further based on a profile associated with the individual, wherein the profile is based on past purchases of the individual from at least one completed historic journey of the individual, and wherein the operations further comprise using historic data to analyze activities of the individual in the ongoing customer journey to obtain the purchases from the at least one completed historic journey of the individual.

5. The non-transitory computer readable medium of claim 1, wherein the information associated with the individual is further based on a profile associated with the individual, and wherein the profile is based on reactions of the individual to presentations made using the display instrument associated with the device.

6. The non-transitory computer readable medium of claim 1, wherein the information associated with the individual is further based on a profile associated with the individual, and wherein the profile is based on a shopping list associated with the individual.

7. The non-transitory computer readable medium of claim 6, wherein the operations further comprise:
receiving a handwritten version of the shopping list;
analyzing the handwritten version to obtain a digital version of the shopping list; and
further basing the profile on at least one of shapes of characters in the handwritten version, sizes of characters in the handwritten version, spacing between characters in the handwritten version, spacing between words in the handwritten version, or spacing between lines in the handwritten version.

8. The non-transitory computer readable medium of claim 1, wherein the operations further comprise:
analyzing the customer journey data to predict a prospective purchase of the individual; and
basing the selection of the action on the predicted prospective purchase.

9. The non-transitory computer readable medium of claim 8, wherein the operations further comprise:
analyzing the customer journey data to determine a confidence level associated with the prediction; and
further basing the selection of the action on the confidence level associated with the predicted prospective purchase.

10. The non-transitory computer readable medium of claim 1, wherein the operations further comprise analyzing the customer journey data to predict a susceptibility of the individual to a recommendation, and wherein the information associated with the individual is based on the predicted susceptibility of the individual to the recommendation.

11. The non-transitory computer readable medium of claim 1, wherein the selected action includes presenting particular content to the individual using a display instrument associated with the device, and wherein the operations further comprise selecting the particular content based on the information associated with the individual.

12. The non-transitory computer readable medium of claim 1, wherein the customer journey data further indicates stops of the device during the ongoing customer journey, and wherein the information associated with the individual is based on the stops of the device during the ongoing customer journey.

13. The non-transitory computer readable medium of claim 1, wherein the customer journey data further indicates purchases made by the individual during the ongoing customer journey, and wherein the information associated with the individual is based on the purchases made by the individual during the ongoing customer journey.

14. The non-transitory computer readable medium of claim 1, wherein the customer journey data further indicates content presented to the individual using an instrument associated with the device during the ongoing customer journey, and wherein the information associated with the individual is based on the content presented to the individual.

15. The non-transitory computer readable medium of claim 1, wherein the customer journey data includes an indication of whether the device returns to a particular region of the retail store after leaving the particular region, and wherein the determination of the information associated with the individual is based on the particular region and on whether the device returns to the particular region of the retail store after leaving the particular region.

16. The non-transitory computer readable medium of claim 15, wherein the customer journey data further includes an indication of a time duration between the leaving the particular region and the returning to the particular region, and wherein the determination of the information associated with the individual is further based on the time duration.

17. The non-transitory computer readable medium of claim 1, wherein the action includes offering, while the ongoing customer journey is in progress, an online purchase opportunity to the individual, the online purchase opportunity is associated with a delivery of a selected product from a first destination to a second destination without passing through the retail store, and wherein the operations further comprise analyzing the information associated with the individual to select at least one of the product or a price associated with the selected product.

18. The non-transitory computer readable medium of claim 1, wherein the information associated with the individual includes a plurality of mathematical objects in a mathematical space, and wherein the operations further comprise:
calculating a mathematical function of the plurality of mathematical objects to obtain a numerical result value; and
basing the selection of the action associated with the individual on the numerical result value.

19. A system for initiating actions based on an ongoing customer journey, the system comprising:
at least one processing unit configured to perform the operations of:
receiving customer journey data associated with an ongoing customer journey, the ongoing customer journey involves an individual and a device associated with the individual in a retail store, the customer journey data indicates a trajectory of the device in the retail store generated based on data captured using an indoor positioning instrument associated with the device;
while the ongoing customer journey is in progress, analyzing the customer journey data to determine information associated with the individual;
using the information associated with the individual to select an action associated with the individual; and
generating a digital signal configured to initiate the selected action.

20. A method for initiating actions based on an ongoing customer journey, the method comprising:
receiving customer journey data associated with an ongoing customer journey, the ongoing customer journey involves an individual and a device associated with the individual in a retail store, the customer journey data indicates a trajectory of the device in the retail store generated based on data captured using an indoor positioning instrument associated with the device;
while the ongoing customer journey is in progress, analyzing the customer journey data to determine information associated with the individual;
using the information associated with the individual to select an action associated with the individual; and
generating a digital signal configured to initiate the selected action.
